(19) United States
(12) Patent Application Publication
(10) Pub. No.: US 2026/0195450 A1
(43) Pub. Date: Jul. 9, 2026

(54) DETECTING ATTACKS ON MACHINE LEARNING SYSTEMS

(71) Applicant: The University of Melbourne, Victoria (AU)

(72) Inventors: Muhammad USMAN, Acton (AU); Maxwell T. WEST, Victoria (AU); Sarah M. ERFANI, Victoria (AU)

(21) Appl. No.: 19/124,830

(22) PCT Filed: Oct. 24, 2023
(86) PCT No.: PCT/AU2023/051059

§ 371 Date: Apr. 25, 2025

(30) Foreign Application Priority Data
Oct. 25, 2022 (AU) 2022903159

(51) Int. Cl. G06F 21/55; G06N 3/094; G06N 10/20

(52) U.S. Cl. CPC G06F 21/554; G06N 3/094; G06N 10/20

(57) ABSTRACT

This disclosure relates to a method for detecting an attack on a machine learning system. A classical neural network comprises a first output indicative of a first classification by the classical neural network and a quantum neural network comprises a second output indicative of a second classification of the input data by the quantum neural network. The method comprises comparing the first output to the second output; and responsive to the first output being different to the second output, generating an indication that an attack is detected.

### CROSS-REFERENCE TO RELATED APPLICATIONS

The present application claims priority from Australian Provisional Patent Application No 2022903159 filed on 25 Oct. 2022, the contents of which are incorporated herein by reference in their entirety.

### TECHNICAL FIELD

This disclosure relates to detecting attacks on machine learning systems.

### BACKGROUND

Machine learning (ML) methods such as artificial neural networks are rapidly becoming ubiquitous in modern science, technology and industry. Despite their accuracy and sophistication, neural networks are plagued by major vulnerabilities, as they can be easily fooled by carefully designed malicious inputs known as adversarial attacks. Such vulnerabilities remain a serious challenge for classical neural networks. Even well trained, high performing neural networks will generally possess serious vulnerabilities to inputs which have been carefully crafted in order to deceive them, despite possibly being all but indistinguishable from genuine inputs which the network can classify easily. This discovery renders the use of artificial neural networks in environments where the input source cannot be trusted a dangerous proposition, and is a key roadblock on the path to widespread deployment of artificial intelligence in general scenarios.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

A method for detecting an attack on a machine learning system comprises:
evaluating a classical neural network on input data, the classical neural network comprising a first output indicative of a first classification by the classical neural network;
evaluating a quantum neural network on the input data, the quantum neural network comprising a second output indicative of a second classification of the input data by the quantum neural network;
comparing the first output to the second output; and
responsive to the first output being different to the second output, generating an indication that an attack is detected.

In some embodiments, the indication comprises an indication that a classical attack is detected.

In some embodiments, the quantum neural network is a quantum variational classifier.

In some embodiments, the classical neural network is configured for image or signals data processing.

In some embodiments, the classical neural network comprises a convolutional neural network and/or a deep neural network.

In some embodiments, the classical neural network comprises a ResNet architecture.

In some embodiments, the method further comprises:
evaluating an adversarially trained classical neural network on the input data, the adversarially trained classical neural network comprising a third output indicative of a third classification by the adversarially trained classical neural network;
comparing the second output to the third output; and
responsive to the second output being different to the third output, generating the indication that an attack is detected.

In some embodiments, the indication comprises an indication that a quantum attack is detected.

In some embodiments, the method further comprises adversarially training the classical neural network by iteratively modifying input data to alter the third output and modifying parameters of the adversarially trained classical neural network to maintain the third output.

A quantum neural network comprises:
an encoder configured to encode input data into multiple qubit states;
multiple layers of quantum gates, each layer comprising for each of the multiple qubit states that encode the input data, multiple rotation gates and a controlled z-gate configured to act between two of the multiple qubit states, wherein the multiple rotation gates are tuneable to train the quantum neural network; and
a measurement module to measure the multiple qubit states at an output of the last layer of the multiple layers configured to output a classification of the input data.

In some embodiments, each layer comprises exactly three rotation gates.

In some embodiments, the controlled z-gate is applied after the multiple rotation gates in each of the multiple layers.

In some embodiments, the controlled z-gate is applied between neighbouring qubits of the multiple qubits.

In some embodiments, the encoder is configured to perform amplitude encoding.

A quantum neural network comprises:
multiple tuneable quantum gates applied to input data of the quantum neural network, and being tuneable to train the quantum neural network to generate a classification of the input data,
wherein the multiple tuneable quantum gates are tuned to provide robustness of the quantum neural network against attacks that modify the input data to alter the classification of the input data.

### BRIEF DESCRIPTION OF DRAWINGS

An example will now be described with reference to the following drawings:

FIG. 1 illustrates a method for detecting an attack on a machine learning system.

FIG. 2 illustrates an architecture for detecting an attack on a machine learning system.

FIG. 3 illustrates a quantum neural network.

FIG. 4 illustrates adversarial machine learning benchmark framework.

FIG. 5 shows schematic depictions of the considered architectures are shown for (a) an example convolutional neural network, (b) ResNet18.

FIG. 6 illustrates training accuracies achieved by classical and quantum networks for various datasets.

FIG. 7 illustrates a simple illustration to show a definition of transferability and defence. The attack is generated by either a classical network or a quantum network (Attack Generation). The effectiveness of the attack generated by a classical(quantum) network when applied to a different classical(quantum) network is defined as Transferability. The robustness of a quantum(classical) network against a classical(quantum) attack is defined as Defence.

FIG. 8 illustrates defence mechanisms and transferability of attacks across classical and quantum networks.

FIG. 9 illustrates the accuracy achieved by classical and quantum networks on sets of 250 adversarially attacked test images from each of the considered datasets in the cases of white-box FGSM attacks on the convolutional network (top row), and 200 layer quantum variational classifier (QVC200, bottom row) as a function of attack strength (measured with the l_{∞} norm). In both cases we see the accuracy of the network under attack decrease sharply. The tendency of the accuracy of the independent networks to also decrease is a manifestation of the transferability of adversarial examples—they are typically capable of fooling even networks which they were not explicitly designed to attack. We see an exception to this in the top row, with the quantum classifier usually resisting the attacks generated with respect to the convolutional neural network.

FIG. 10 illustrates the accuracy achieved by classical and quantum networks on sets of 250 adversarially attacked test images from each of the considered datasets in the cases of white-box AutoAttacks on the convolutional network (top row), and 200 layer quantum variational classifier (QVC200, bottom row) as a function of attack strength (measured with the l_{∞} norm). In both cases we see the accuracy of the network under attack decrease sharply. The tendency of the accuracy of the independent networks to also decrease is a manifestation of the transferability of adversarial examples—they are typically capable of fooling even networks which they were not explicitly designed to attack. We see an exception to this in the top row, with the quantum classifier largely resisting the attacks generated with respect to the convolutional neural network.

FIG. 11 illustrates content of adversarial perturbations.

FIG. 12 illustrates adversarial perturbations generated by ∈=0.1 PGD attacks on the convolutional neural network, ResNet18 and the 500 layer quantum variational classifier (QVC500) are shown for several examples from the MNIST and Cifar-10 databases.

FIG. 13 illustrates adversarial perturbations generated by ∈=0.1 FGSM attacks on the convolutional neural network, ResNet18 and the 500 layer quantum variational classifier (QVC500) are shown for several examples from the FMNIST and Celeb-A databases.

FIG. 14 illustrates adversarial perturbations generated by ∈=0.1 FGSM attacks on the convolutional neural network, ResNet18 and the 500 layer quantum variational classifier (QVC500) are shown for several examples from the MNIST and Cifar-10 databases.

FIG. 15 a,b. illustrates the accuracies achieved by classical and quantum networks trained with PGD attacks.

FIG. 16 illustrates accuracies achieved by classical and quantum networks on a set of 250 adversarially attacked test images from the MNIST dataset in the cases of white-box attacks on the ConvNet. The attack is applied to adversarially trained ConvNets (ConvNet^{0.1}, ConvNet^{0.2}, and ConvNet^{0.3} which are adversarially trained with PGD attacks of (I_{∞}) strength 0.1, 0.2 and 0.3 respectively), QVC200 and adversarially trained QVC200 networks (QVC200^{0.1}, QVC200^{0.2}, and QVC200^{0.3} which are adversarially trained with PGD attacks of (I_{∞}) strength 0.1, 0.2 and 0.3 respectively) as a function of attack strength. In both cases, we see the accuracy of ConvNet decrease sharply when under white-box attack. The adversarial training significantly increases the accuracy of classical networks, but makes a negligible difference for the quantum networks. c,d. The accuracies achieved by ConvNet, ConvNet^{0.1}, ConvNet^{0.2}, ConvNet^{0.3}, QVC200^{0.1}, QVC200^{0.2}, and QVC200^{0.3} on the MNIST dataset in the case of white-box attacks on the QVC200. The classical networks exhibit high accuracy when adversarially trained. As before, adversarial training makes negligible difference to the accuracy of the QVC200. e. The adversarial perturbations generated by PGD attacks on ConvNet, ConvNet^{0.1}, ConvNet^{0.2}, and ConvNet^{0.3} for a sample image from the FMNIST dataset. While the perturbation for ConvNet exhibits highly abstract features which are incomprehensible to humans, the perturbations from the adversarial training show much more systematic features, reminiscence of quantum networks. f. The adversarial perturbations generated by PGD attacks on QVC200, QVC200^{0.1}, QVC200^{0.2}, and QVC200^{0.3} for a sample image from the MNIST dataset. The perturbations from the adversarially trained QVCs are very similar to those from the QVC which underwent standard training.

FIG. 17 illustrates accuracies as in FIG. 15 but using the FGSM attack.

FIG. 18 illustrates accuracies as in FIG. 15 but using the AutoAttack.

FIG. 19 illustrates the adversarial perturbations generated by ∈=0.1 PGD attacks on ConvNet and QVC200, with and without adversarial training, for several examples from the FMNIST dataset. The QVCs and the adversarially trained ConvNets display large-scale features whose meaning is often understandable, unlike ConvNet with standard training.

FIG. 20 illustrates The accuracies of QVCs of various depths on images generated by a PGD attack on ConvNet. We find that increasing the depth of the quantum networks has a limited effect on both clean accuracy and adversarial robustness.

FIG. 21 is a diagram exhibiting the plots of the learning accuracy of QVC200 network for the MNIST dataset under various noisy simulation environments.

FIG. 22 illustrates an overall summary of attacks and defence of classical and quantum networks based on simulations. Under classical attacks, the classical networks are vulnerable due to the strong transferability of classical adversarial attacks, however rigorous adversarial training leads to robust outcomes. Contrarily, quantum networks are robust with and without adversarial training. In the case of attacks generated from quantum networks, the classical networks were found to be vulnerable but become robust after rigorous adversarial training. Contrarily, quantum networks are highly vulnerable against quantum attacks—indicating that much more work needs to be done to optimise quantum network architectures to achieve resilience against quantum attack transferability.

FIG. 23 illustrates the accuracy achieved by the quantum variational classifiers on test sets of 250 images from each dataset throughout the training process. We see consistent but modest gains in accuracy as a function of model size in the cases of MNIST and FMNIST (10 class classification problems), but less consistency in the cases of CIFAR-2 and Celeb-A (binary classification problems).

FIG. 24 illustrates a Quantum Adversarial Machine Learning and a quantum classifier architecture for the example of signals processing.

FIG. 25 shows a pseudo-code for the PCA-based UAP algorithm.

FIGS. 26a and 26b provide a visualization of signal data. FIG. 26a shows the visualization of an example signal data when encoded with exact amplitude encoding. FIG. 26b shows the visualization of the same signal data when encoded with the disclosed approximate amplitude encoding method.

FIG. 27 illustrates the performance achieved by QVC (triangles), AAE-QVC (black) and CNN (dots) in the case of white-box UAP, FGSM and PGD attacks on the GNU radio ML dataset and a synthetic dataset as a function of attack strength defined as perturbation-to-signal ratio (PSR). Figure (a) to (c) represent the performance under white-box UAP attack for binary RML dataset, multi-class RML dataset and synthetic dataset respectively. Figure (d) to (f) represent the performance under white-box FGSM attack for binary RML dataset, multi-class RML dataset and synthetic dataset respectively. Figure (g) to (i) represent the performance under white-box PGD attack for binary RML dataset, multi-class RML dataset and synthetic dataset respectively. The dash lines represent the initial accuracy of the three models without any attacks. Across different attacks and datasets, we can see that even though CNN usually has the highest initial accuracy, AAE-QVC is generally the most robust among the three models, followed by QVC. However, AAE-QVC and QVC become vulnerable as the attack strength increases.

FIG. 28 illustrates the performance achieved by QVC (triangles), AAE-QVC (diamonds) and CNN (dots) in the case of black-box UAP, FGSM and PGD attacks on the GNU radio ML dataset and synthetic dataset as a function of attack strength defined as perturbation-to-signal ratio (PSR). Figure (a) to (c) represent the performance against black-box UAP attack for binary, multi-class RML dataset and synthetic dataset respectively. Figure (d) to (f) represent the performance against black-box FGSM attack for binary, multi-class RML dataset and synthetic dataset respectively. Figure (g) to (i) represent the performance under black-box PGD attack for binary RML dataset, multi-class RML dataset and synthetic dataset respectively. The dash lines represent the initial accuracy of the three models without any attacks. Across different attacks and datasets, we witness that attacks generated on quantum classifiers transfer well to classical CNN models that the accuracy of the CNN models decreases sharply. These adversarial examples are capable of fooling the neural networks which they are not explicitly designed to attack. However, the converse is not true. Quantum classifiers largely resist the attacks generated on CNN models.

FIG. 29 illustrates the structure of the encoding QVC, U(θ), used to produce approximate amplitudes. It consists of 8 qubits and 5 variational layers of a R_{X}, R_{Z} and R_{Y} sequence, followed by a 2-qubit C-NOT gate. Each layer contains 3 trainable parameters θᵢⱼₖ per qubit/wire, where the subscripts i, j and k denote the qubit index, layer index and gate index, respectively.

FIG. 30 illustrates the performance achieved by AAE-QVC with Depolarizing noise (orange), AAE-QVC (black) and CNN (blue) in the case of black-box UAP, FGSM and PGD attacks on the multi-class RML radio ML dataset. Figure (a) to (c) represent the performance against blackbox UAP, FGSM and PGD attacks respectively. The dash lines represent the initial accuracy of the three models without any attacks

FIG. 31 illustrates a pseudo-code for a Two-sample Kolmogorov-Smirnov goodness of fit test (KS-test).

FIG. 32 provides a visualization of GNU Radio ML dataset for three different modulation classes at the SNR=16 dB.

FIG. 33 provides a visualization of the Synthetic Fourier Series dataset. Three different types of periodic signals, square waves, sawtooth waves and triangle waves are generated in the dataset. Each data point has added Gaussian noise and has varying frequency. Figure (a) to (c) show the visualization of the three different periodic signals respectively.

FIG. 34 illustrates a visualization of an FGSM attack with PSR=−42 [dB] on signal data with modulation class equals GFSK. The original signal data is shown on the left. The perturbated signal data is shown on the right.

### DESCRIPTION OF EMBODIMENTS

This disclosure relates to detecting attacks on machine learning systems. In particular, this disclosure relates to detecting attacks that alter input data that is to be classified with the aim of an incorrect classification. In some examples, the altered input data looks identical to the original input data to the human eye, but still leads to a misclassification. For example, images or other signals may be altered to lead to an incorrect classification. This is often possible because the machine learning systems are trained on a specific training data set, which makes them not generally transferable and therefore not robust against these attacks. In other words, trained machine learning models are reliable to classify a similar type of input data, but if the input data is altered in a way that is not in the training set, the trained machine learning model may misclassify the data.

### Method for Detecting Attacks

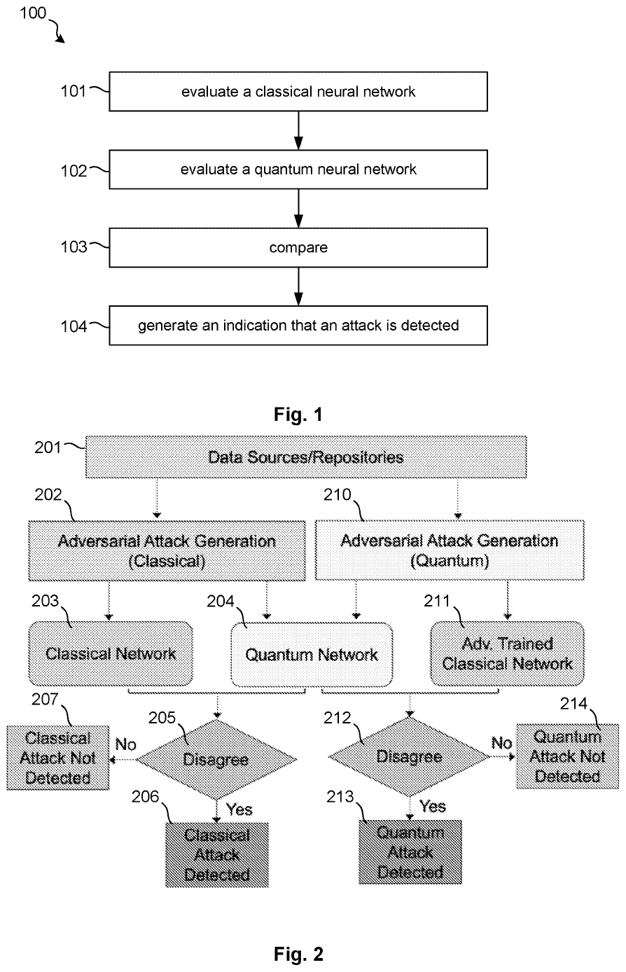

FIG. 1 illustrates a method 100 for detecting an attack on a machine learning system, such as a neural network. The method is performed by a processor of a classical computer. This means method 100 is implemented as program code that is stored on a non-transitory computer readable medium, such as a solid state drive or hard disk drive. The program code causes the processor to perform the methods disclosed herein, such as method 100. The processor may further be connected volatile and non-volatile data memory to store electronic data, such as machine learning models and model parameters as well as training data and test data.

As such, the processor evaluates 101 a classical neural network on input data. This means the processor uses the input data as the input to the classical neural network and applies the operations with the learned parameters to the input data, such as convolutions with trained filters. The classical neural network comprises an output that is indicative of a classification by the classical neural network.

For example, the classical neural network may be trained to detect objects in an image, such as vehicles. Therefore, the output of the classical neural network is indicative of a classification of the image data as containing a vehicle by the neural network. The training may be performed using gradient descent and backpropagation while using labelled training images as input data to reduce the error between the labels and the output of the neural network.

The processor also evaluates 102 a quantum neural network on the input data. Again, the quantum neural network comprises an output indicative of a classification of the input data by the quantum neural network. As will be shown below, the quantum neural network is robust against alterations of the input data by a classical adversary, that is, an adversary using classical computers to alter the input data. As a result, the output classification of the quantum neural network should be correct while the output of the classical neural network may be incorrect.

The processor compares 103 the output from the classical neural network to the output from the quantum neural network. Responsive to the classical output being different to the quantum output, the processor generates 104 an indication that an attack is detected. This may be an indication that a classical attack has been detected, which is in contrast to a quantum attack. This indication may take various forms, such as a message to an administrator, including email and SMS, an API call to a monitoring system, a display message on a user interface or other indications.

It is also possible that the processor takes mitigation action, such as banning the current user, shutting down, cutting a network connection, or other action. In some examples, the classification relates to an autonomous vehicle and so in response to detecting an attack, the vehicle may enter a safe mode, stop moving, return home, or other mitigation action.

In some examples, the quantum neural network is a quantum variational classifier and the classical neural network is configured for image or signals data processing and comprises a convolutional neural network and/or a deep neural network, such as a ResNet architecture.

In order to further improve method 100, it is possible to add an adversarially trained classical neural network. Adversarially training the classical neural network means iteratively modifying input data with the aim of altering the output of the network and modifying parameters of the adversarially trained classical neural network to maintain the output.

The processor can then evaluate the adversarially trained classical neural network on the input data. The adversarially trained classical neural network comprises a third output indicative of a third classification by the adversarially trained classical neural network. Again, the processor compares the quantum output to the adversarial output and responsive to the outputs being different, the processor generates the indication that an attack is detected. This indication may be an indication that a quantum attack is detected.

### Flowchart for Attack Detection

FIG. 2 illustrates a flowchart diagram of the disclosed attack detection strategy based on a hybrid quantum/classical approach. FIG. 2 has a data source 201, such as images or signals. An attacker uses a generator 202 that is a classical computer to generate an adversarial attack. The processor evaluates a classical network 203 and a quantum network 204 to calculate respective outputs. A comparator 205 determines whether the two output disagree. If they do disagree, the processor generates an indication 206 that the classical attack is detected. If they do agree, the processor may generate an indication 207 that no classical attack is detected.

A more sophisticated attacker may use a quantum generator 210 to generate an adversarial quantum attack. In order to make the detection robust against quantum attacks, the system comprises an adversarially trained classical network 211 that uses the input data to generate another output. A comparator 212 compares the output from quantum network 204 and from adversarially trained classical network 211. If the outputs disagree, the processor generate an indication 213 that the quantum attack is detected. Otherwise, the processor generates an indication 214 that the quantum attack is not detected.

In other words, a classical attack is detected when the predictions of the classical and quantum networks disagree. A quantum attack is detected when the predictions of the quantum and adversarially trained classical network disagree.

### Quantum Neural Network

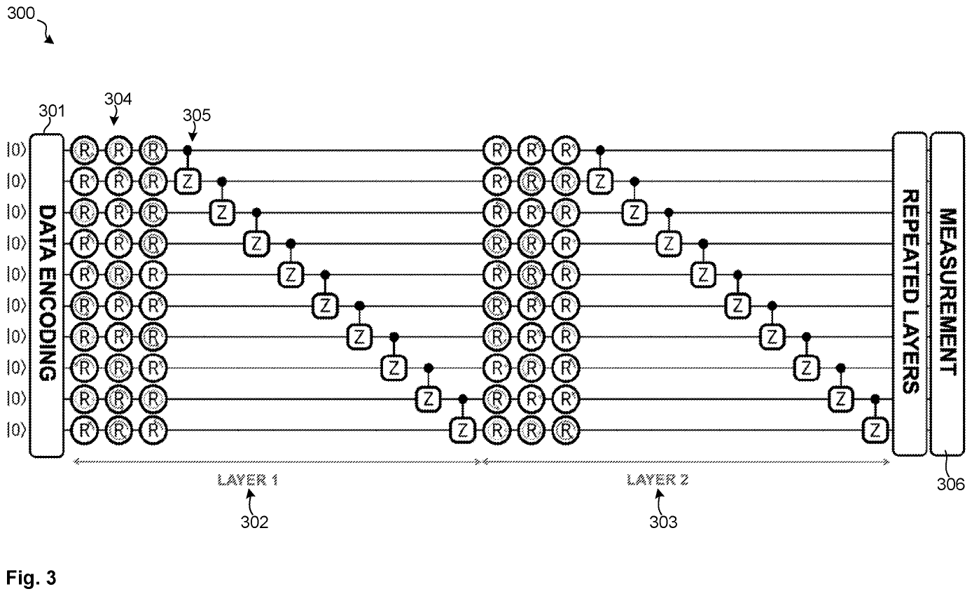

FIG. 3 illustrates a quantum neural network 300 that may be evaluated in method 100 on the input data to calculate a quantum classification of the input data. Quantum neural network 300 comprises an encoder 301 that encodes input data into multiple qubit states. In the example of FIG. 3, the input data is encoded into 10 qubits but a different number of qubits may equally be used. Further, the encoder 301 uses amplitude encoding but other schemes are also usable. In the amplitude encoding (or also referred to as amplitude-embedding technique), every quantum system is described by its wave function ψ which also defines the measurement probabilities. By expressing that the wave function is used to encode data, it is therefore implied that amplitudes of the quantum system are used to represent data values. Amplitude encoding is described in LaRose, R. & Coyle, B. Robust data encodings for quantum classifiers. Physical Review A 102, 032420 (2020), which is included herein by reference.

In some examples, the encoding is lossless in the sense that every piece of information in the input data can be obtained by decoding the encoded qubits. In other examples, the encoding maintains only the most relevant data, similar to an auto-encoder or an embedding. This way the number of qubits can be reduced so that the disclosed method can be performed on quantum computers with a relatively small number of qubits.

Quantum neural network 300 further comprises multiple layers of quantum gates. In FIG. 3 only a first layer 302 and a second layer 303 are shown, but more layers (such as 200 layers) can be used. Each layer 302/303 comprises for each of the multiple qubit states that encode the input data, multiple rotation gates 304. That is, the first qubit state has multiple rotation gates, and the second qubit state has multiple rotation gates and so on. In this example, each qubit state has exactly three rotation gates. The rotation gates are parameterised by the angle of rotation. That parameter, that is, the angle of rotation, is adjusted during training to reduce an error between the output of the quantum neural network and the labels of the training data.

Each layer 302/303 further comprises a controlled z-gate 305. The controlled z-gates 305 are configured to act between two of the multiple qubit states. For example, the second qubit state is subject to a z-operation that is controlled by the first qubit state. Here, the z-operations are applied between neighbouring qubit states, that is, the z-operation on one qubit state is controlled by the neighbouring qubit state. This also supports the implementation in a range of physical quantum computing hardware.

Finally, quantum neural network 300 comprises a measurement module 306 that measures the multiple qubit states at an output of the last layer of the multiple layers. This observes and collapses the qubit states and generates as an output the quantum classification of the input data.

In this sense, the quantum neural network 300 comprises multiple tuneable quantum gates 304 applied to input data of the quantum neural network, and being tuneable to train the quantum neural network to generate a classification of the input data. The multiple tuneable quantum gates 304 are tuned to provide robustness of the quantum neural network against attacks that modify the input data to alter the classification of the input data.

### Benchmarking

The following description provides further information on the benchmarking of classical neural networks, quantum neural networks and adversarially trained classical neural networks.

This disclosure evaluates the robustness of quantum networks under true vulnerability tests through benchmarking their performance at scale for complex datasets (beyond MNIST) such as FMNIST, CIFAR, and Celeb-A and by creating black-box attacks, in which the adversary generates an attack without precise knowledge of quantum network structure, the phenomena which is also referred to as the transferability of adversarial examples.

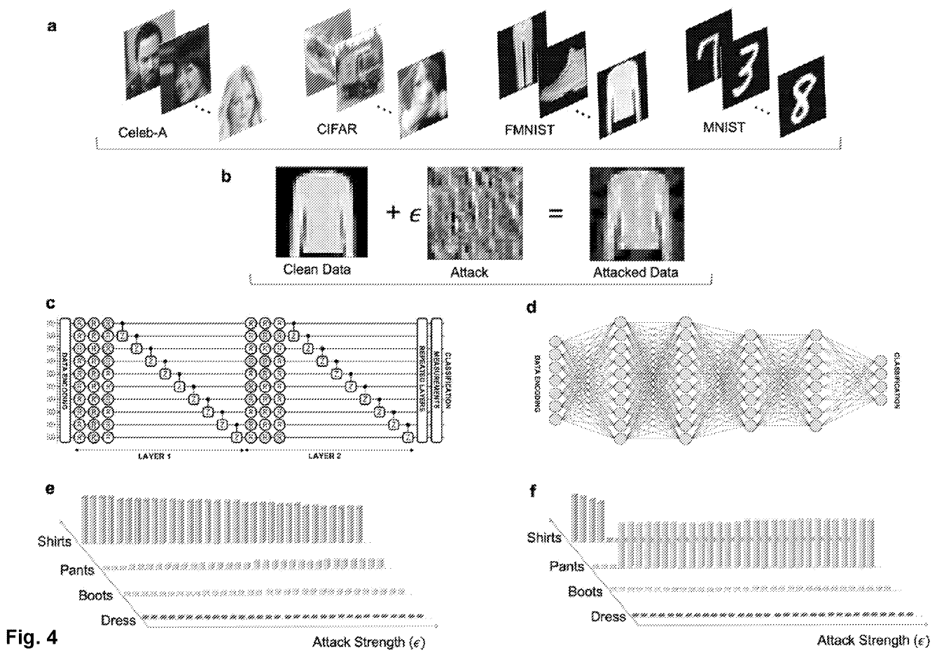

FIG. 4 illustrates a flowchart diagram of the quantum/classical adversarial ML framework developed to benchmark their robustness against a range of sophisticated adversarial attacks. a. A variety of image datasets (MNIST, FMNIST, CIFAR and Celeb-A) are selected to train and test classical and quantum networks. b. For each image dataset, adversarial attacks (PGD, FGSM, and AutoAttack) are generated with variable strengths controlled by ∈ (with respect to the l_{∞} norm). Importantly, generate both quantum and classical attacks to test their transferability across networks i.e. quantum attacks on classical networks and vice versa. c. Schematic diagram of a quantum variational classifier (QVC) network trained and tested in this work as describe with reference to FIG. 3. The QVC network consists of a data loading layer where the input image data is amplitude encoded into a quantum state. The variational part of the QVC consists of a repeated pattern of layers—two such layers are shown. The QVC networks are labelled based on the number of repeated layers e.g. a QVC200 network contains 200 layers. The final stage of the network is a measurement layer which determines the classification label. d. Two classical neural networks (ConvNet and ResNet) were trained to directly compare their performance against the quantum networks. The exact configurations of the classical networks are described in the Methods section. e, f. depict the performance of a quantum and a classical network against an adversarial attack, where a small, carefully chosen perturbation is added to an image which is then passed to both a neural network and a quantum variational classifier for classification. The probabilities that are assigned to various labels by the networks are shown as a function of the strength of the attack. At a certain critical attack strength the correct label (“Shirts”, shown in orange) is no longer considered the most probable by the classical network (in f), and the attack has succeeded in fooling it. Contrarily the same attacked image when passed to a quantum variational classifier is still correctly predicted as “Shirts” (in e), even when the attack strength is increased well beyond what is tolerated by the classical network.

By carrying out a systematic set of quantum and classical simulations across a range of image datasets and a variety of adversarial attacks, we analyse and compare both the defence of classical(quantum) networks against quantum(classical) adversarial attacks, and the transferability of adversarial examples within classical and quantum ML methods in black box setting. This disclosure compares the performance of quantum variational classifiers (QVCs), classical convolutional neural networks (CNNs) and the classical neural network architecture ResNet18, as an example, which comprises 18 layers with shortcut connections added to each pair of 3×3 filters as described in He, K., Zhang, X., Ren, S. & Sun, J. Deep residual learning for image recognition. In Proceedings of the IEEE conference on computer vision and pattern recognition, 770-778 (2016), which is incorporated herein by reference.

The results reveal a surprising discovery that, while the adversarial examples constructed by carrying out white box attacks on the QVCs tend to transfer well to the classical networks, the converse is not true, with the QVCs displaying a remarkable resilience to the classical adversarial attacks (see FIG. 4) in black box setting. The analysis of perturbations generated from classical and quantum attacks, indicates that the observed difference between classical and quantum defence mechanisms manifests from a result of the QVCs learning a different, but highly meaningful, set of features to the classical networks, which rely on informative but non-robust features of the data.

We also investigate the performance of adversarial training of classical and quantum networks, which provides an important insight that while quite successful for classical networks, adversarial training only negligibly impacts the performance of the quantum network. Finally, this disclosure provides a novel adversarial attack detection technology which relies on classical and quantum ML frameworks both working together to rapidly identify the presence of an adversarial attack. Overall, the results establish that the future deployment of quantum ML solutions in security conscious practical applications offers a new kind of advantage in terms of robustness of ML frameworks against adversarial attacks, which is orthogonal to the commonly sought enhancements in speed and/or accuracy.

### Results and Discussions

The testing and benchmarking of QAML models involve selection of datasets, generation of adversarial attacks, implementation of classical and quantum ML models and a systematic investigation of attack transferability and defence. This disclosure investigates QAML across a diverse set of well-known image datasets, including both grey-scale (MNIST and FMNIST), and RGB colour (CIFAR and Celeb-A) images. While we use all ten classes of the MNIST and FMNIST datasets, some examples are restricted to binary classification (ships vs trucks) in the case of CIFAR in order to reduce the computational burden of training the large quantum classifiers. But non-binary and multi-class classification is equally possible. The classification challenge considered for the Celeb-A dataset is to determine whether the pictured person has black hair. Example images from each of the datasets are shown in FIG. 4(a). After the selection of datasets, three different types of adversarial attacks were applied: PGD, FGSM, and AutoAttack. These are some of the strongest attacks to test and benchmark the adversarial vulnerability of classical neural networks.

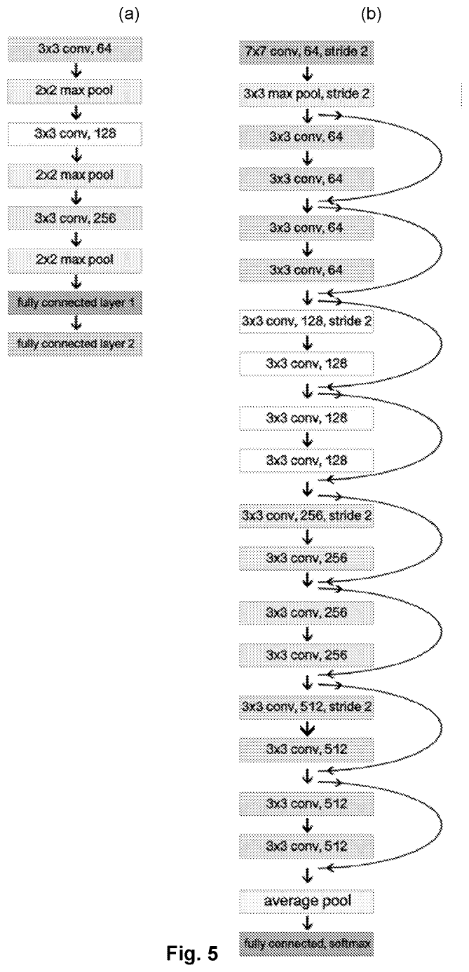

On the quantum side, one example uses standard quantum variational classifiers (QVCs), while on the classical side, one example uses convolutional neural networks (henceforth labelled as ConvNet for simplicity) and the network architecture ResNet18 (henceforth labelled as ResNet for simplicity). The architectures of ConvNet, ResNet, and the QVCs are schematically shown in FIG. 5. The processor loads the images into the QVCs with the method of amplitude encoding, which can access the entire, exponentially large, Hilbert space of the quantum computer.

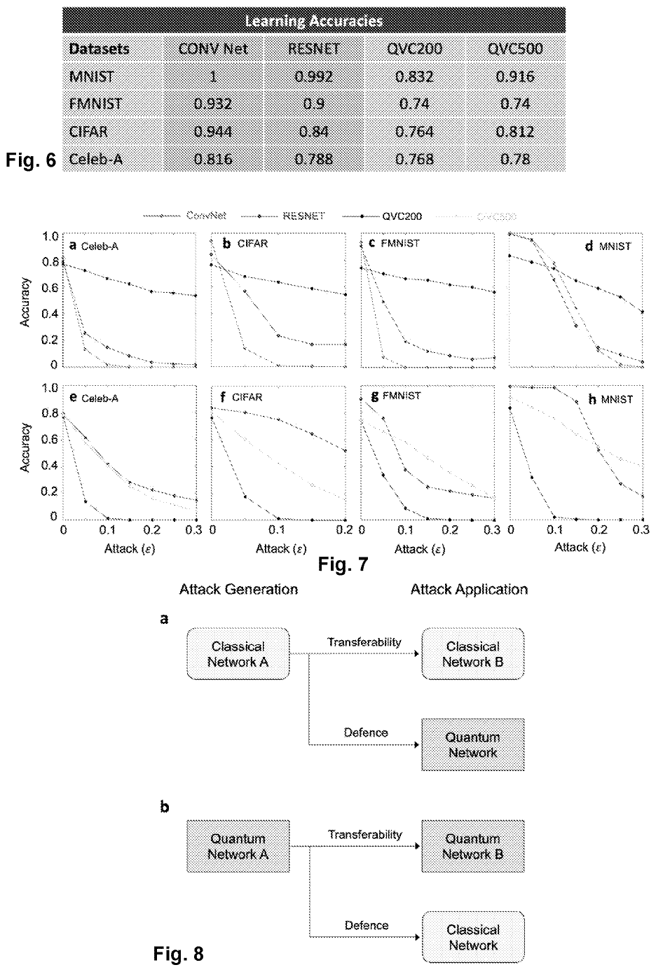

The processor is therefore able to encode the 28×28 grey-scale images of the MNIST and FMNIST datasets into 10 qubits, and the 3×32×32 RGB images of CIFAR and Celeb-A into 12 qubits (as 28×28<2¹⁰ and 3×32×32<2¹²). After encoding, the resulting quantum state is processed by a variable number of layers of parametrised (trainable) single-qubit rotations and entangling CZ gates (refer to FIG. 3). The QVC networks are labelled based on the number of layers in the architecture, e.g., QVC200 consists of 200 layers. Both classical and quantum networks were rigorously trained to achieve high accuracies (see details in Table below and FIG. 6). The learning accuracies of QVCs trained in this disclosure are close to the outcomes from the classical networks even for complex RGB datasets (CIFAR and Celeb-A) and despite that the classical networks utilise significantly more resources than the QVCs. Further details pertaining to the QVC architectures, CNNs, ResNet, and their training procedures are provided below.

FIG. 7 illustrates experimental results regarding transferability and defence. The accuracy achieved by classical and quantum networks on sets of 250 adversarially attacked test images from each of the considered datasets in the cases of white-box PGD attacks on the convolutional network (top row), and 200 layer quantum variational classifier (QVC200, bottom row) as a function of attack strength ∈ (measured with the l_{∞} norm). In both cases we see the accuracy of the network under attack decrease sharply. The tendency of the accuracy of the independent networks to also decrease is a manifestation of the transferability of adversarial examples—they are typically capable of fooling even networks which they were not explicitly designed to attack. We see an exception to this in the top row, with the quantum classifier largely resisting the attacks generated with respect to the convolutional neural network.

### Adversarial Attack Transferability and Defence.

An example testing and benchmarking process of classical and quantum ML networks involves two steps: (1) Adversarial examples created by various white-box attacks on a classical network, e.g., ConvNet and their application to a different classical network, e.g., ResNet, which analyses the transferability of attacks, as the attack generation and testing is done on two entirely different architectures. In quantum case, this could be performed by generating adversarial examples on, e.g., QVC200 network and assessing its transferability to a QVC500 network. (2) Adversarial examples created by various white box attacks on a classical network such as ConvNet and their application to quantum network (QVC200) which evaluates the defence of a quantum network against that classical attack. This also involved the testing of the defence of the classical networks (ConvNet and ResNet) against the attacks generated from quantum networks such as QVC200. FIG. 8 provides a simple illustration that defines defence mechanisms and transferability of attacks across classical and quantum networks.

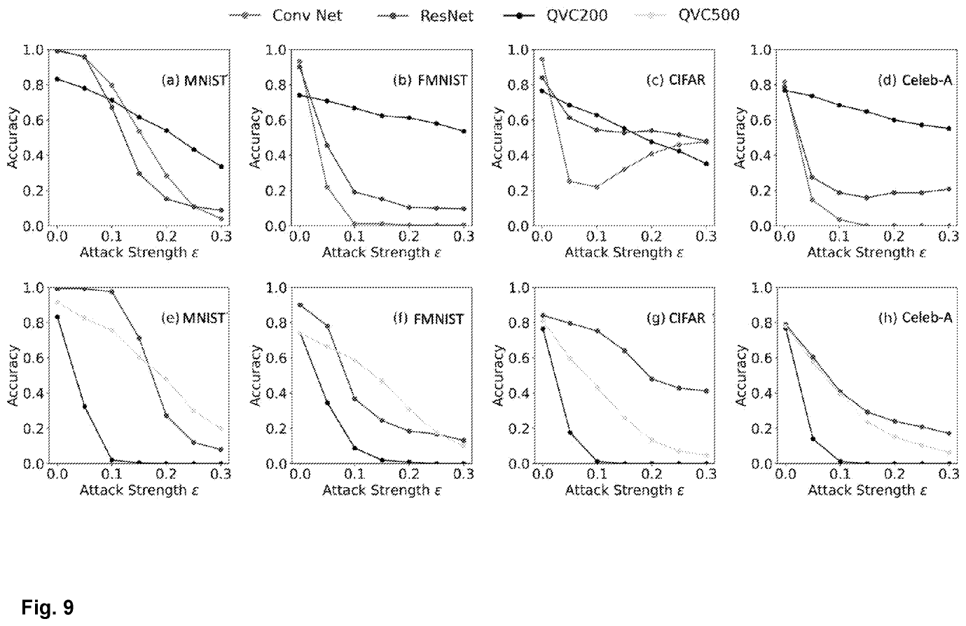

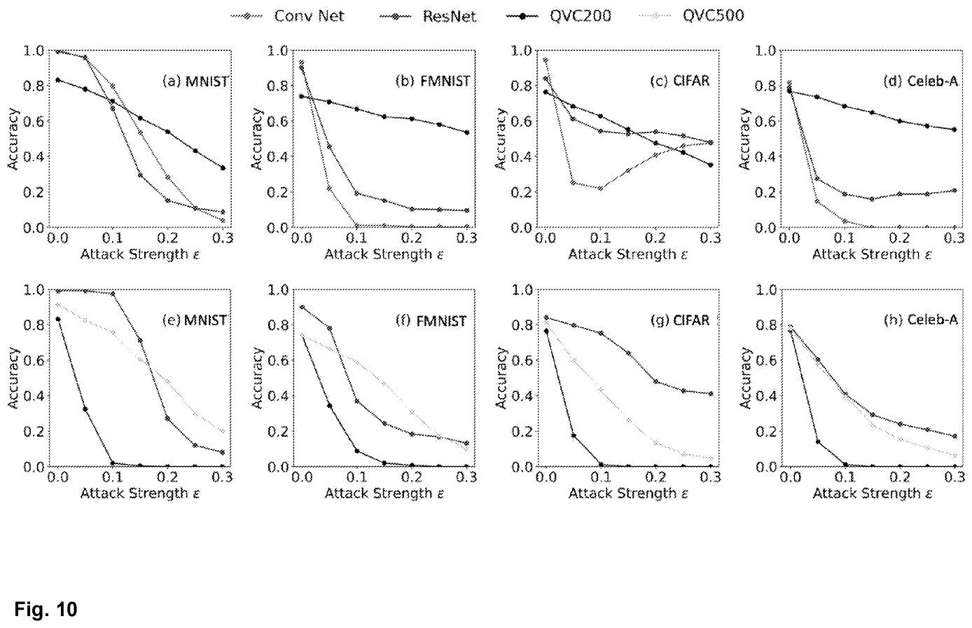

FIG. 7 plots our results benchmarking the transferability and defence of both classical and quantum networks for all four datasets in the presence of PGD attacks. The corresponding results for FGSM and AutoAttack are plotted in FIGS. 9 and 10, respectively, which exhibit very similar trends. Regarding the transferability of adversarial attacks (from one classical network to another classical network, and from one quantum network to another quantum network), along the top row (a-d) of FIG. 7, we witness the transferability of adversarial examples between independent classical networks: adversarial examples created by various white box attacks on ConvNet transfer well to ResNet, despite it having an entirely different architecture. Being under white box attack, the accuracy of the ConvNet itself falls quickly (the bottom lines). The accuracy of an independent classical network, ResNet, also falls quite rapidly (the middle lines), demonstrating the transferability of adversarial attacks in the classical setting, and as seen in FIG. 7 (a-d).

The bottom row (e-h) of FIG. 7 shows, similarly, a successful transfer of adversarial examples generated by a white box attack on QVC200 to an independently trained QVC500 network, although the transferability across quantum networks is relatively weak compared to the classical case. This is perhaps due to the fact that both QVC200 and QVC500 share the same architectural design, with the only difference being the circuit depths, or number of layers. FIG. 7 (e-h) show that the accuracy of QVC200 itself falls rapidly in the face of the adversarial examples which are being generated specifically with respect to it (the bottom lines), as does that of QVC500 (the middle lines), demonstrating the successful transferability between two QVC networks. QVC200 demonstrates a significant vulnerability to white box adversarial attack, and the successful transfer of these attacks to QVC500 demonstrates that the quantum networks are also utilising non-robust features.

Regarding the defence of classical networks against a quantum attack and vice versa, As exhibited by the results plotted in FIG. 7 (a-d), in the presence of PGD attacks generated from the classical ConvNet for various datasets, the QVC200 network demonstrates far superior robustness, retaining reasonable accuracies even in the face of very strong attacks, i.e., ∈≥0.2. Conversely, the results plotted in FIG. 7 (e-h) show a failure of the classical networks to maintain their accuracy in the face of adversarial examples generated by attacks on the QVC200 networks. Similar conclusions can be drawn from Supplementary FIGS. 9 and 10, where classical and quantum defences are tested in the presence of adversarial examples generated by FGSM and AutoAttack.

### Adversarial Perturbations.

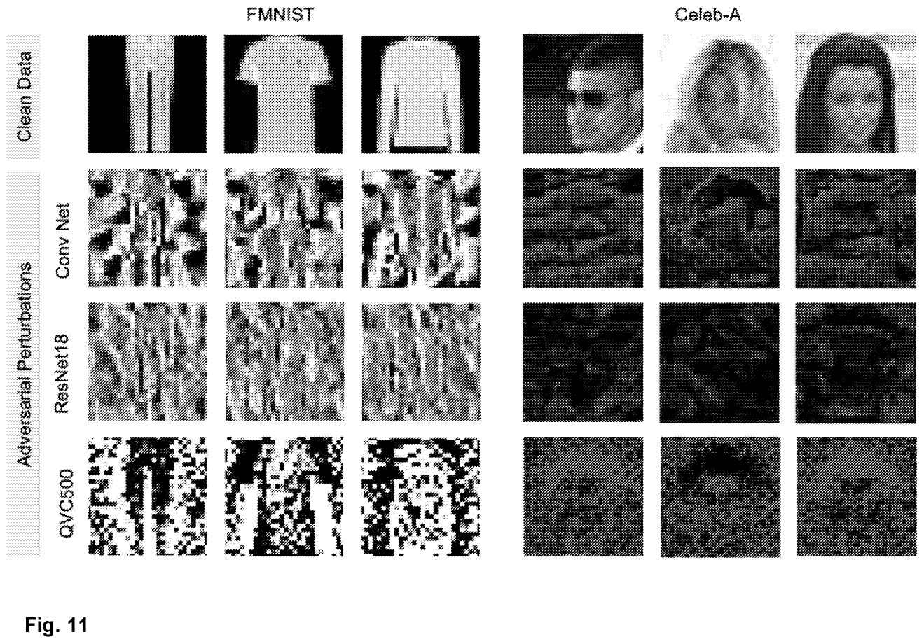

FIG. 11 illustrates content of adversarial perturbations. The adversarial perturbations generated by ∈=0.1 PGD attacks on the convolutional neural network, ResNet and the 500 layer quantum variational classifier (QVC500) are shown for several examples from the FMNIST and Celeb-A databases. In the case of FMNIST the task is to distinguish between classes of images representing various types of clothing, e.g. t-shirts, pants, shoes, while in the case of Celeb-A the classification problem is to determine whether or not the featured person has black hair. The perturbations generated by the classical networks are incomprehensible to humans, exploiting the highly abstract features discovered by these networks. The attack on the QVC, on the other hand, yields perturbations whose semantic content is clear; they constitute concrete steps towards actually changing the label of the clean image (i.e. filling in the gap between the legs of the pants, adding sleeves to the t-shirt, removing sleeves from the jumper, changing the hair colour of the imaged person).

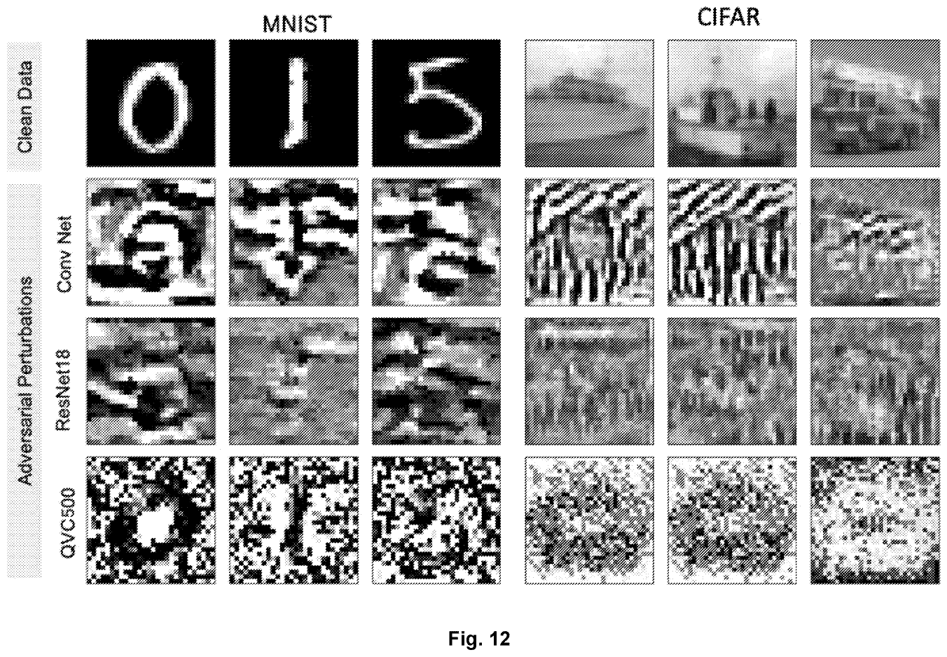

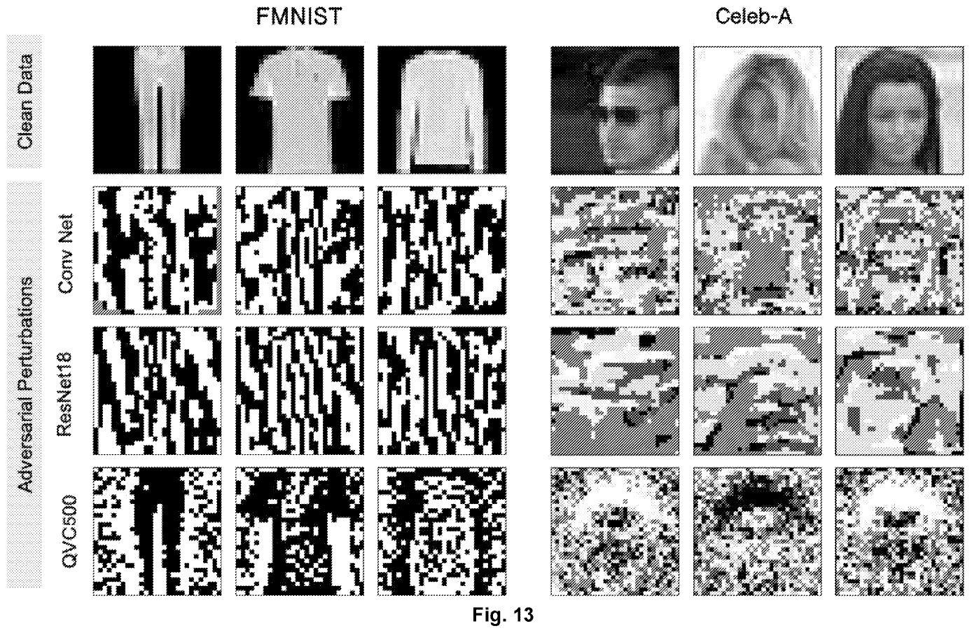

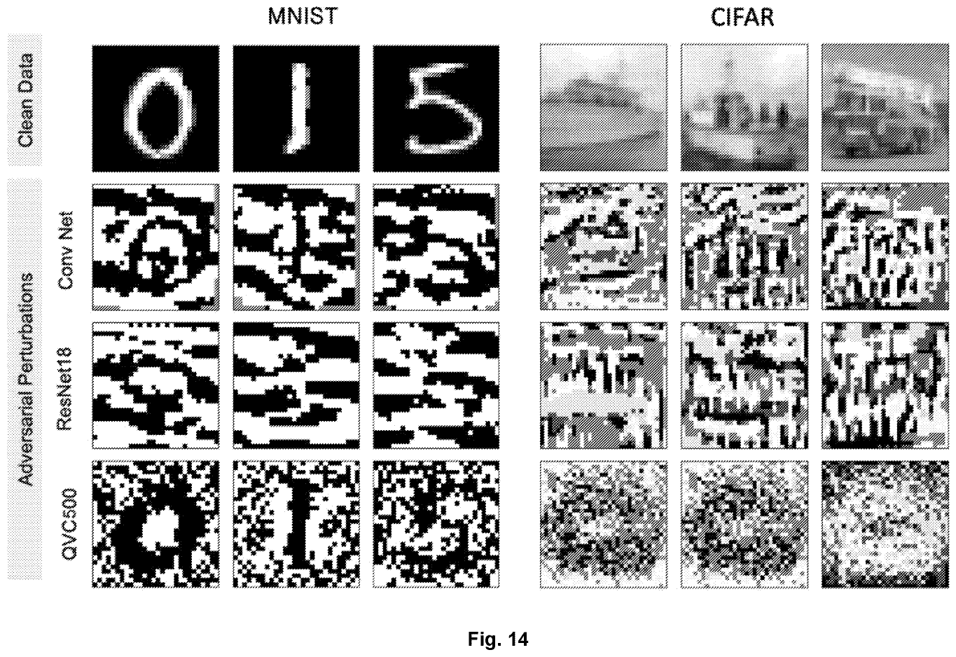

To gain further insight into the success of the quantum networks in resisting the classical adversarial attacks, and conversely the failure of the classical networks to do the same, we plot the adversarial perturbations generated by PGD attacks on ConvNet, ResNet, and the 500 layer QVC on examples from the FMNIST and Celeb-A datasets in FIG. 11. Similar examples from the MNIST and CIFAR datasets are shown in FIG. 12, along with perturbations from the FGSM attack in FIGS. 13 and 14. These perturbations highlight a very similar trend. The perturbations generated in the attacks on the classical networks display complicated high-frequency patterns, which are not readily human understandable. The fact that these “worst case” perturbations (from the networks' perspective) take such a form is indicative of the fact that the classical neural networks have learnt to classify the images by identifying extremely complicated patterns in the data rather than a more human-like recognition of the large scale features in the images. While these features may be highly informative, the fact that classical networks tend to independently discover similar sets of them contributes to the vulnerability of the networks to transferred attacks, as the features can then be simultaneously targeted by an adversarial attack on any one of the classifiers individually. The inability of the attacks to transfer to the QVCs then indicates that the quantum models are utilising a different set of features.

Indeed, the perturbations generated by attacking QVC200 demonstrate a markedly different story: in each case we can clearly identify meaningful information in the perturbation. For example, in the first column of FIG. 11, the perturbation is filling in the gap between the legs of the pants, which would indeed alter the true label of the image were the perturbation strong enough. Similarly, in the second column we see the attack adding sleeves to the T-shirt, and in the third column removing them. On the right hand side, where the classification task is to determine whether or not the pictured person has black hair, we can again see meaningful perturbations generated by the QVC, either lightening or darkening the hair of the pictured person so as to change the label of the data sample image. The fact that, in the case of the QVC, the “worst case perturbations” do genuinely correspond to efficiently changing the true label of the sample, rather than incomprehensible noise as is the case for classical networks, implies that the QVC is learning more robust patterns in the data, and so is not easily fooled except by meaningful perturbations. Remarkably, the ability of the QVCs to display similar behaviour despite having undergone only standard (non-adversarial) training is highly interesting and is an indication of a quantum advantage in ML tasks.

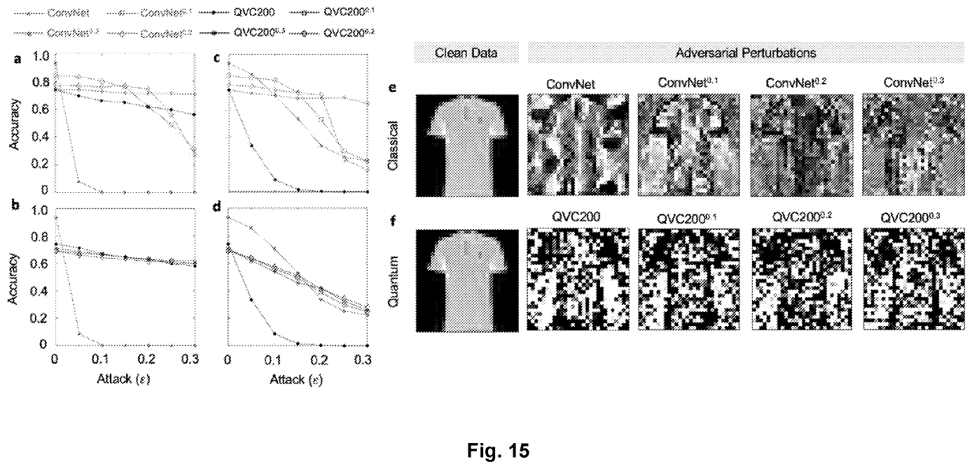

FIG. 15 illustrates the accuracies achieved by classical and quantum networks on a set of 250 adversarially attacked test images from the FMNIST dataset in the cases of white-box attacks on the ConvNet. The attack is applied to adversarially trained ConvNets (ConvNet^{0.1}, ConvNet^{0.2}, and ConvNet^{0.3} which are adversarially trained with PGD attacks of (I_{∞}) strength 0.1, 0.2 and 0.3 respectively), QVC200 and adversarially trained QVC200 networks (QVC200^{0.1}, QVC200^{0.2}, and QVC200^{0.3} which are adversarially trained with PGD attacks of (I_{∞}) strength 0.1, 0.2 and 0.3 respectively) as a function of attack strength. In both cases, we see the accuracy of ConvNet decrease sharply when under white-box attack. The adversarial training significantly increases the accuracy of classical networks, but makes a negligible difference for the quantum networks. c,d. The accuracies achieved by ConvNet, ConvNet^{0.1}, ConvNet^{0.2}, ConvNet^{0.3}, QVC200^{0.1}, QVC200^{0.2}, and QVC200^{0.3} on the FMNIST dataset in the case of white-box attacks on the QVC200. The classical networks exhibit high accuracy when adversarially trained. As before, adversarial training makes negligible difference to the accuracy of the QVC200. e. The adversarial perturbations generated by PGD attacks on ConvNet, ConvNet^{0.1}, ConvNet^{0.2}, and ConvNet^{0.3} for a sample image from the FMNIST dataset. While the perturbation for ConvNet exhibits highly abstract features which are incomprehensible to humans, the perturbations from the adversarial training show much more systematic features, reminiscence of quantum networks. f. The adversarial perturbations generated by PGD attacks on QVC200, QVC200^{0.1}, QVC200^{0.2}, and QVC200^{0.3} for a sample image from the FMNIST dataset. The perturbation corresponding to QVC200 shows the presence of clear features which actually change the label of the clean image (i.e. adding sleeves to the t-shirt. The perturbations from adversarially trained QVCs are very similar to the QVC which underwent standard training.

The qualitative differences between the classical and quantum perturbation landscapes explain both the success of the QVC adversarial examples in transferring to the classical networks, and the failure of the adversarial examples generated by attacking ConvNet to transfer to the QVCs. The classical networks rely on non-robust, but highly informative features which allow them to achieve high accuracy on clean data, but are highly susceptible to adversarial attacks. As the QVCs do not seem to rely on such features to the same extent, an adversarial attack which targets them is limited in its ability to fool the QVCs, but the attacks on QVC200 transfer well to the classical networks by virtue of their meaningful content.

These findings suggest extending the distinction between robust and non-robust features to include a third category, classically intractable features. While these classically intractable features may themselves be robust or non-robust, they may be robust against classically generated attacks in practice, while susceptible at most to adversarial quantum perturbations generated by attacking a quantum model. The QVCs studied in this disclosure have discovered features consistent with this classically intractable but non-robust category, being susceptible to attacks transferred from quantum models, but not classical ones. The investigation of quantum models which are also robust against attacks transferred from quantum classifiers is an interesting direction for future work. Adversarial Training.

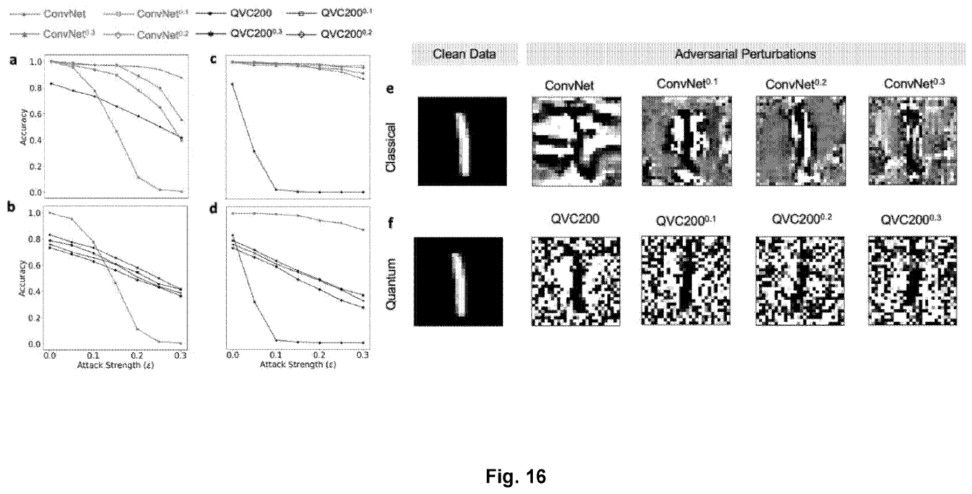

This disclosure assesses the capability of adversarial training for both the classical convolutional network (ConvNet) and the QVC200 quantum network in the context of the FMNIST dataset, with the training-time adversarial examples generated by the PGD attack with ∈=0.1, 0.2 and 0.3. The deep QML network undergoes adversarial training with complex multi-class data, i.e., all ten classes of the FMNIST dataset in FIG. 15 (a-d), and all ten classes of the MNIST dataset in Supplementary FIG. 16.

Due to the extensive computational requirements, we leave the adversarial training of the 12-qubit classifiers employed for the CIFAR and Celeb-A datasets to a future study.

We plot in FIG. 15 (a-d) the results of adversarial attacks on ConvNet and QVC200 both with and without adversarial training. In (a,b), ConvNet is attacked in a white box setting and the attack is transferred to adversarially trained ConvNets and QVCs. We use superscripts to indicate the strength of the attacks used in the adversarial training, i.e., the labels ConvNet^{x} and QVC200^{x} indicate adversarial training with perturbations of l_{∞} norm x, where x∈{0.1, 0.2, 0.3}. Our results in (a) show that adversarial training is capable of endowing the classical networks with considerable robustness to attacks of strength less than or equal to that on which it was trained, consistent with earlier findings. Therefore, ConvNet^{0.3} exhibits very robust accuracy against attacks transferred from ConvNet as it was trained on images attacked with a strength of 0.3, even exhibiting a slightly better accuracy than that of QVC200. However, we note that adversarial training comes at the cost of reduced accuracy of the network on clean data (∈=0) as well as being notoriously computationally expensive. Interestingly, the adversarial training of QVC200 has almost no impact on its accuracy when attacked by adversarial images generated from ConvNet. This is perhaps due to the fact that, even when undergoing standard training, the QVC networks learnt features quite similar to those they learnt when undergoing adversarial training (see FIG. 15 (f)). Therefore, their susceptibility (or lack thereof) to a given attack is similar. This is in contrast to the classical networks, which will default to learning non-robust features unless they are explicitly trained in an adversarial setting.

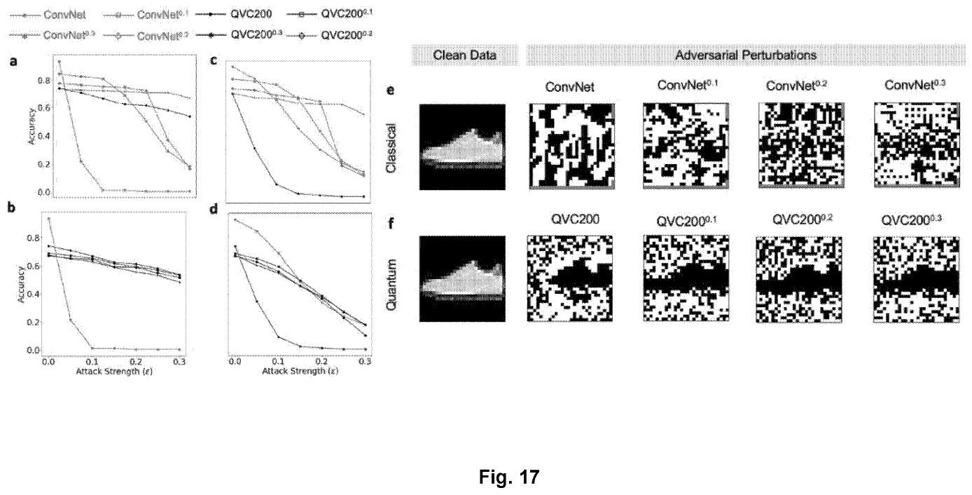

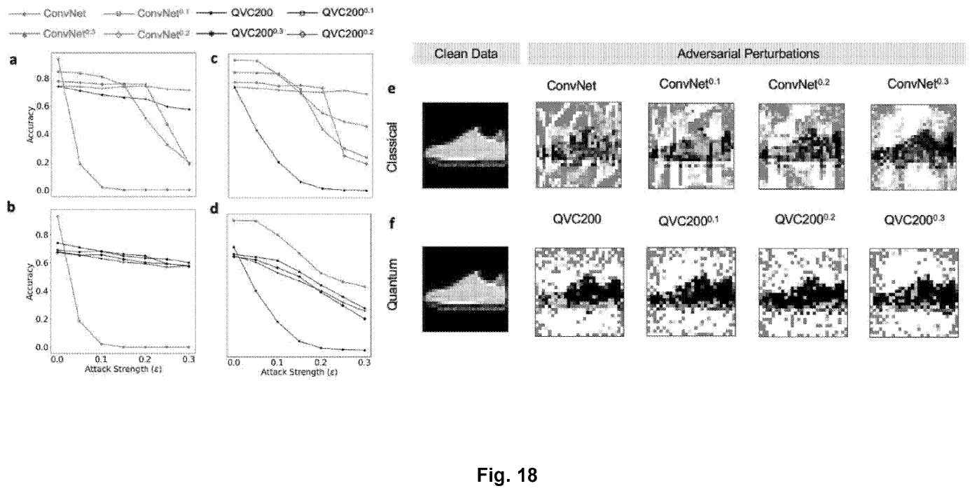

The results based on quantum attacks transferred to adversarially trained ConvNet are very striking as shown in FIG. 15 (c). While ConvNet failed to maintain its accuracy when attacked by QVC200, the adversarially trained ConvNets show very similar resilience as in (a) when they were attacked by classical attack. These results show that rigorous adversarial training of classical networks may provide a method of defending against quantum attacks. Finally, FIG. 15 (d) shows our results based on transferring quantum attacks to adversarially trained QVC200 networks. Again, the adversarial training has very little impact on the accuracy of the QVC200, which is consistent with (b). We also note that the effect of adversarial training in the presence of FGSM attacks is qualitatively similar to the PGD attacks as indicated from the results in Supplementary FIGS. 17 and 18.

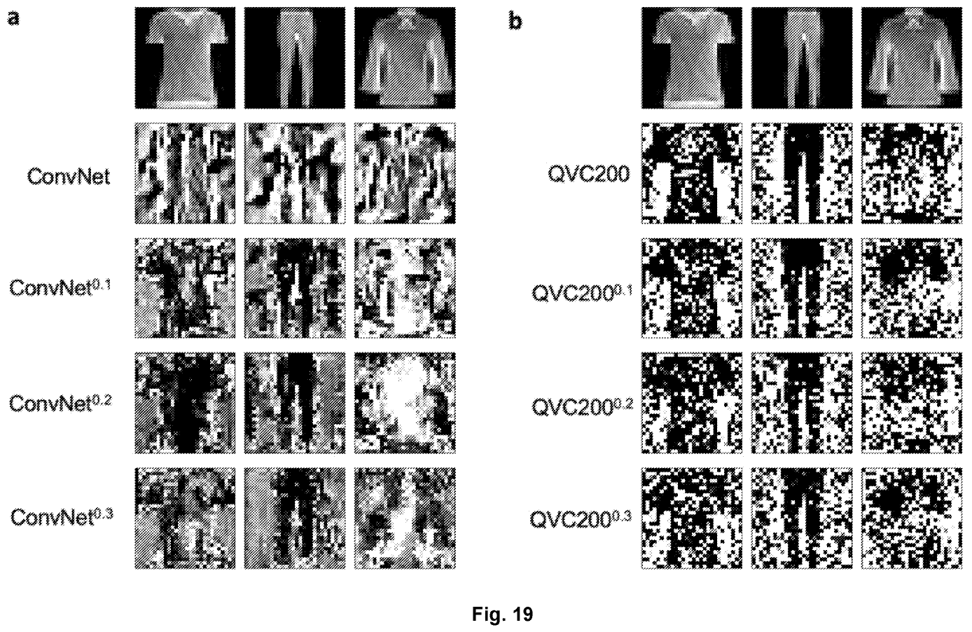

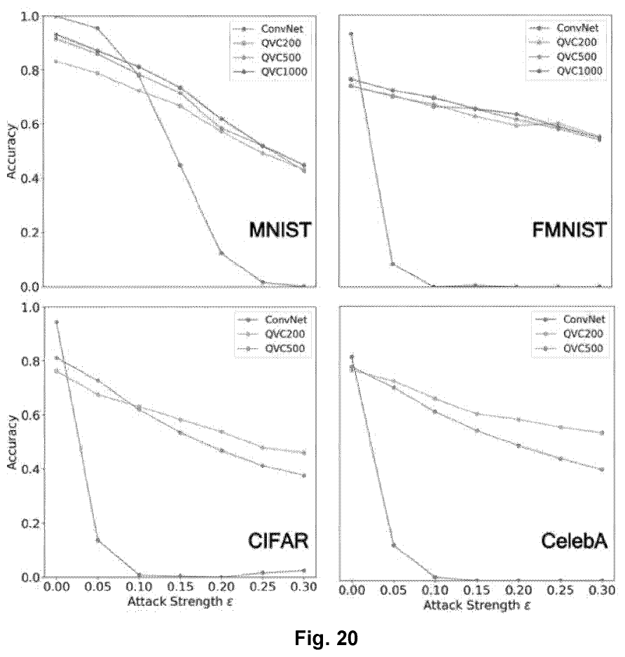

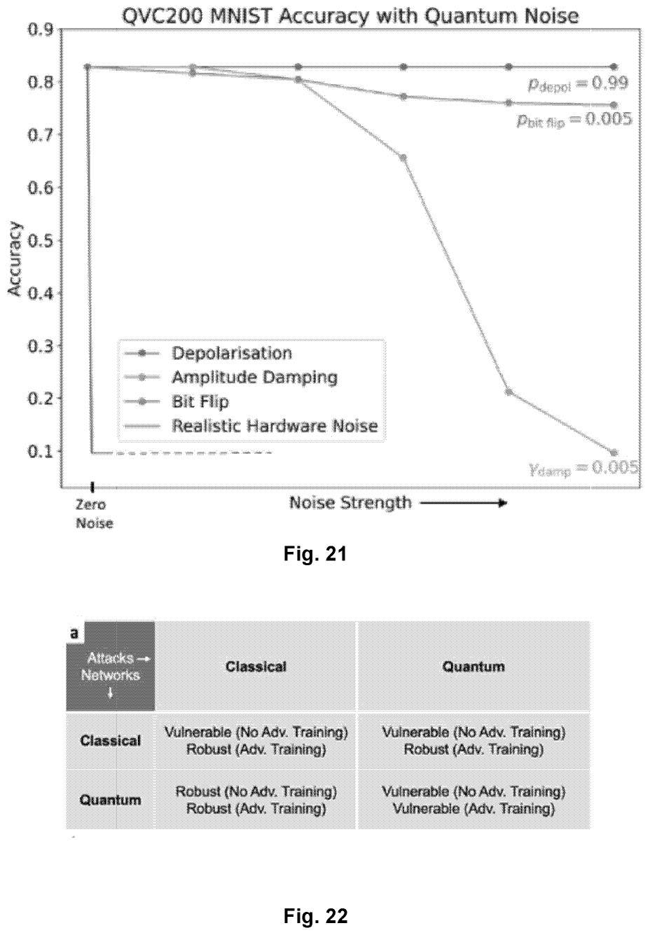

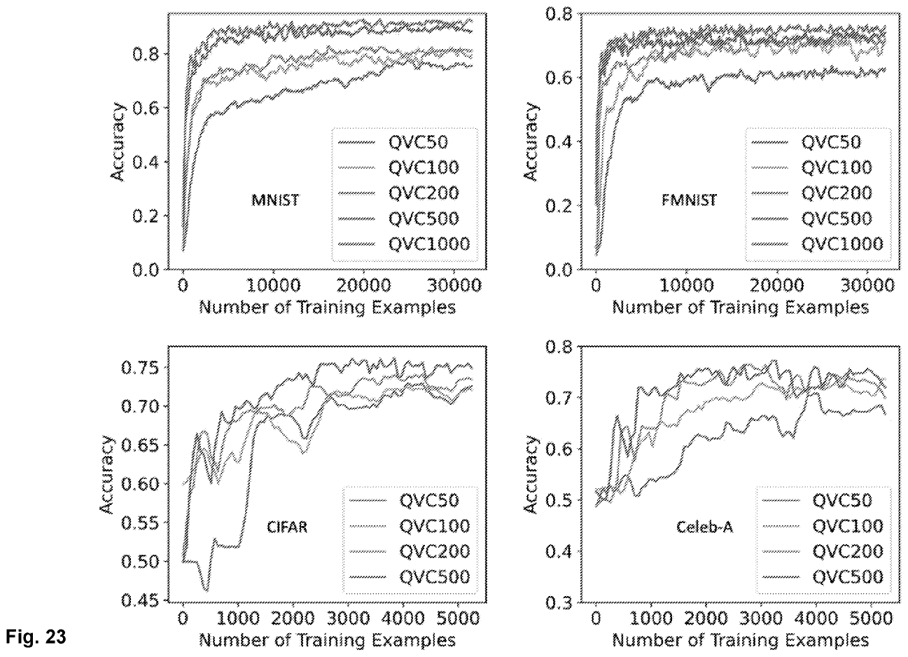

To gain further insight into the adversarial training and its impact on the accuracy of the classical and quantum networks, we show the perturbations generated by adversarial attacks on networks both with and without adversarial training in FIG. 15 (e, f). Further examples of such images are shown in FIG. 19. The perturbations generated by attacks on the adversarially trained models display meaningful semantic content comparable to those generated by attacking the (regularly trained) QVCs. This explains the observed robustness in FIG. 15 (a-d) for both the quantum and adversarially trained classical cases. Moreover, from the similarity between the perturbations generated by the standard and adversarially trained QVCs, we infer that they have learnt similar features, explaining their similar performance in FIG. 15 (a-d). Adversarial Attack Detection.

FIG. 21 shows the overall summary of our results based on the analysis of various attacks on quantum and classical networks trained and tested for a variety of datasets. When the adversarial attack is generated from a classical network, it exhibits very strong transferability across other classical networks and hence they are vulnerable against such attacks. However, rigorous adversarial training restores the accuracy of classical networks, providing a reliable defence mechanism. On the other hand, the classical attacks transfer poorly to the quantum networks, which remain robust against such attacks, with or without adversarial training. In fact, our results reveal that adversarial training makes only a minor difference to the performance of our quantum networks. In the case of quantum attacks, the classical networks show poor accuracy unless they are adversarially trained. Strikingly, the quantum networks remain vulnerable to quantum attacks, with adversarial training again making almost no difference in their performance.

FIG. 21 illustrates an overall summary of attacks and defence of classical and quantum networks based on our simulations. Under classical attacks, the classical networks are vulnerable due to the strong transferability of classical adversarial attacks, however rigorous adversarial training leads to robust outcomes. Contrarily, quantum networks are robust with and without adversarial training. In the case of attacks generated from quantum networks, the classical networks were found to be vulnerable but become robust after rigorous adversarial training. Contrarily, quantum networks are highly vulnerable against quantum attacks—indicating that much more work needs to be done to optimise quantum network architectures to achieve resilience against quantum attack transferability. Based on these results and their systematic analysis, there is provided a simple attack detection strategy which will be highly useful in practical settings where a rapid detection of adversarial attacks is crucial for reliable practice of ML based solutions. The flowchart diagram in FIG. 2 illustrates our attack detection technology which is based on the hybrid operation of classical and quantum networks working in conjunction to detect the presence of an adversarial attack. In the disclosed strategy, a classical attack is detected if the outcomes from a classical and a quantum network disagree. On the other hand, a quantum attack is detected if the outcomes from an adversarially trained classical network and a quantum network disagree. These strategies are inferred from our results plotted in FIG. 15 (b) and (c) for the FMNIST dataset under PGD attacks. Similar results are shown for the FMNIST dataset using FGSM and AutoAttack (FIGS. 17 and 18) and also for the MNIST dataset (FIG. 16). Summary

While some examples herein relate to image data, on the disclosed methods may equally be applied to other data types (e.g. audio, text, the environment of reinforcement learning agents, and fully quantum data).

It is further noted that the disclosed general purpose QVCs may be replaced by quantum generalisations of convolutional neural networks in order to construct models whose performance on image data exhibits more favourable scaling with model size.

In summary, vulnerability to adversarial examples has emerged as a serious issue confronting classical ML algorithms, raising ongoing concerns about their security and reliability when classifying data from untrusted sources. In the case of quantum ML, too, a similar susceptibility exists, and adversarial examples may be reckoned with if the field is to achieve its expected revolutionary potential. This disclosure addresses an important gap in the QAML literature by thoroughly studying the transferability of adversarial examples between classical and quantum neural networks in the context of common image datasets, discovering a surprising one-way resiliency between quantum and classical networks as a result of the quantum classifiers automatically learning robust features. Our results hint at a new pathway to quantum advantage in ML: quantum classifiers which may not be necessarily more accurate than their classical counterparts, but exhibit superior robustness to classically generated adversarial attacks.

### Experimental Details

Dataset Selection: This disclosure considers a diverse range of standard image datasets, including MNIST (28×28, greyscale), FMNIST (28×28, greyscale), CIFAR-10 (32×32, RGB), Celeb-A (32×32, RGB) and Tiny Imagenet (64×64, RGB).

Attack Generation: This disclosure consider a range of standard white-box adversarial attacks developed in the classical setting, including PGD, AutoAttack and FGSM. In all cases the strength ∈ of the attacks is measured with respect to the l_{∞}-norm.

Classical Network Implementations: Our convolutional neural network begins with three layers of 3×3 filters, containing 64, 128 and 256 feature maps respectively, with 2×2 maxpooling and the ReLu activation function. These convolutional layers are followed by two fully connected layers, which also utilise the ReLu activation function. The networks were implemented in Pytorch and trained with the Adam optimiser and the cross-entropy loss function.

Quantum Network Implementations: Our QVCs follow a standard three step process for processing the input image data before outputting a predicted label. In the first step the images are encoded into a quantum state via the method of amplitude encoding. In the second step the encoded images are processed by passing through a parameterised quantum circuit consisting of a variable number of layers, with each layer consisting of a parameterised rotation to each qubit followed by nearest neighbour CZ gates. In this work we employ deep circuits with 200, 500 or 1000 layers. Finally, in the third step we measure the z expectation value of the first m qubits, where m is the number of classes in the particular classification problem being considered. The prediction of the QVC is defined to be the index of the highest of these values. Further details may be found in the Supplementary Materials. The QVCs were implemented in Pennylane and trained with the Adam optimiser and the cross-entropy loss function.

Adversarial Training: We employ adversarial training with the PGD attack with 3 gradient descent steps. Each batch of training examples consists of 50% clean and 50% adversarial examples.

Quantum Noise: We test our QVCs in the presence of depolarisation noise, amplitude damping, bit flips and (simulated) realistic hardware noise. The results may be found in the Supplementary Materials. Depolarisation Noise: In this model, the state of the system is replaced with the maximally mixed state with probability p which indicates the strength of the noise. Amplitude Damping: This model is a quantum channel which gives a simple model for relaxation of an excited state to the ground state. In the qubit case, with some probability there is a spontaneous transition |0 [symbol] →|1 [symbol] . The lifetime is governed by a parameter γ, which determines the strength of the noise. Bit-flip: In this model, an X gate is applied with probability p, which determines the strength of the noise. Realistic Hardware Noise: In this model, we have used hardware noise directly modelled from IBM Quantum devices.

### Network Architectures

The disclosed convolutional neural network begins with three layers of 3×3 filters, containing 64, 128 and 256 feature maps respectively, with 2×2 maxpooling and the ReLu activation function. These convolutional layers are followed by two fully connected layers, which also utilise the ReLu activation function. Both the classical and quantum networks are trained with the Adam optimiser and the cross-entropy loss function. Further details of the network architectures are shown in the table below.

TABLE 1
The resource requirements for the different networks considered.
In all cases the quantum variational classifiers require drastically
less trainable parameters than their classical counterparts.

| | MNIST and FMNIST | | | CIFAR-10 and Celeb-A | | |
|---|---|---|---|---|---|---|
| | | Param- | | | Param- | |
| Network | Qubits | eters | Layers | Qubits | eters | Layers |
| ConvNet | — | ~10⁶ | 5 | — | ~10⁶ | 5 |
| ResNet18 | — | ~10⁷ | 10 | — | ~10⁷ | 18 |
| QVC200 | 10 | 6000 | 200 | 12 | 7200 | 200 |
| QVC500 | 10 | 15000 | 500 | 12 | 18000 | 500 |
| QVC1000 | 10 | 30000 | 1000 | — | — | — |

### Adversarial Machine Learning

One aspect of adversarial machine learning is that standard ML frameworks are highly susceptible to being deceived by subtle, malicious tampering with their input data. The results of such tampering, adversarial examples, can be readily produced by taking a data sample (which for a high performing ML method will likely be correctly classified) and attempting to find a tiny perturbation which when added to the data causes a misclassification. By insisting that the perturbation is small one guarantees that the true label of the constructed adversarial example is the same as the label of the original data point, despite the model classifying them differently if the attack is successful.

Concretely, suppose that we are attempting to train a classifier to label data from a set χ, with corresponding labels from another set γ. The goal of supervised machine learning is then to learn a parameterised function C_{θ}:χ→γ in order to minimise the empirical loss obtained on a given training set consisting of pairs (xᵢ,yᵢ) of labelled examples:

$$θ = arg {min}_{{θ}^{′} ∈ Θ} \frac{1}{N} {\sum }_{i} ℒ ( {C}_{{θ}^{′}} ( {x}_{i} ) , {y}_{i} ) \qquad ( 1 )$$

where Θ is the set of possible parameter values, and [symbol] is a chosen loss function (e.g. the cross-entropy loss). Alternately, in the setting of adversarial machine learning, one is given a trained classifier C_{θ} and an input sample x, and seeks to construct an adversarial perturbation δ_{adv} by maximising the loss function:

$${δ}_{adv} = arg {max}_{δ ∈ Δ} ℒ ( {C}_{θ} ( x + δ ) , y ) \qquad ( 2 )$$

where Δ is the set of allowable (i.e. acceptably small) perturbations. While the optimisation problem of Equation 2 may be highly nonconvex and analytically intractable, many strong strategies (“types of attacks”) have emerged for tackling it in practice. This disclosure considers three attacks, namely projected gradient descent (PGD), the fast gradient sign method (FGSM), and Auto Attack.

An important classification of adversarial attacks is into white-box and black-box attacks. In a white box attack, the adversary is assumed to have full access to the network under attack, including familiarity with its architecture and the values of its weights and biases. As a result, the adversary possesses the ability to differentiate with respect to an input to the network, and therefore carry out optimisation based attacks such as the PGD, FGSM and Auto attacks considered here. While such attacks generally have a devastating effect on the accuracy of a network, the assumption of such intimate familiarity with the target network may not always be satisfied.

A more realistic case is that where the adversary has access to the target network only through submitting queries, and is therefore forced to attempt a black-box attack. The feasibility of black box attacks stems largely from the discovery of the remarkable transferability of adversarial examples between various ML frameworks: adversarial examples constructed to attack a specific target tend to transfer to entirely independent networks, deceiving them as well. This discovery alleviates the need for direct access to a network in order to reliably attack it; the adversary may construct a network of their own, perform a white box attack on it, and then simply submit the generated adversarial examples to the target network. The transferability of adversarial examples between classical and quantum networks is the main topic of study in this work.

### Quantum Machine Learning

The quantum machine learning (QML) models disclosed herein belong to the category of quantum variational classifiers (QVCs). As in the classical case, these models will be parameterised functions [symbol] :χ [symbol] γ, where we consider an input set χ with associated labels from a further set γ and denote a QVC parameterised by parameters θ as [symbol] Our QVCs follow a standard three step process for processing the input image data before outputting a predicted label. In the first step the images are encoded into a quantum state. Due to the strong limitations on the numbers of qubits currently available to quantum computers and simulators, and our need to encode high dimensional image data, we employ the method of amplitude encoding. Having represented the image by a vector x containing its pixel values, amplitude encoding is the mapping

$$x ↦ {\sum }_{i = 0}^{{2}^{n}} {x}_{i} i \qquad ( 3 )$$

where the set

$${\{ i \}}_{i = 0}^{{2}^{n} - 1}$$

forms the computational basis of the Hilbert space. As amplitude encoding makes use of the entire Hilbert space, which has a dimension exponentially large in the number of qubits, it can encode a vector x∈ [symbol] into ┌log₂(m)┐ qubits. This extreme compression allows to encode images into a manageable number of qubits; in the case of the MNIST and FMNIST datasets, which consist of 28×28 greyscale images, only 10 qubits are needed, while for the 3×32×32 RGB images from the CIFAR-10 and CelebA datasets, 12 qubits are required. In both cases, zeros are appended to the input vectors in order to make their length a power of two. Having loaded the images into the quantum model in the first stage, in the second stage they are processed by passing through a parameterised quantum circuit, the parameters of which are updated during training to minimise the average cross entropy loss on the training dataset as in Equation 1. In one example, parameterised circuits are chosen consisting of a variable number of layers, with each layer consisting of a parameterised rotation to each qubit followed by nearest neighbour CZ gates. This disclosure provides deep circuits with 200, 500 or 1000 layers. Finally, in the third stage a set of measurements are performed in order to determine the predicted output label. The measurement module measures the z expectation value of the first m qubits, where m is the number of classes in the particular classification problem being considered (10 for MNIST and FMNIST, 2 for CIFAR-10 and CelebA). Given an input x, then, the final output of the quantum classifier is

$${𝒜}_{θ} ( x ) = arg {max}_{k \leq m} [ {U}_{θ} ( x ) {σ}_{k}^{z} ] \qquad ( 4 )$$

where we denote the unitary representing the action of the parameterised quantum circuit on the input x by U_{θ}(x). The procedure is depicted in FIG. 4.

### Signals Application

The following part of this disclosure provides an application of quantum machine learning algorithm on radio signal classification and a study of its robustness to various adversarial attacks, with a focus on comparing the performance of quantum variational classifiers (QVCs) and classical convolutional neural networks (CNNs). It is noted that details provided above with respect to image data is equally applicable to the examples below with respect to radio and other time-domain signals and vice versa. The reference to “we”, “our” and other pronouns is a reference to the inventors and such statements are part of this disclosure to provide further details and experimental data regarding the claimed invention.

In particular, the inventors carried out an extensive set of quantum and classical simulations across concrete radio-frequency examples and synthetic Fourier series waveform dataset, which cover different scenarios with different attack strategies, including fast gradient sign method, projected gradient descent, and universal adversarial perturbations in the white-box and black-box attack setting. Our results clearly highlight that adversarial examples generated by attacking a classical model fails to fool quantum classifiers. However, perturbations generated by quantum attacks transfer well to classical models and are capable of deceiving classical models.

We also investigate the attack stealthiness of the perturbations generated by QVCs and classical CNNs. Moreover, in order to encode classical data more efficiently into quantum states, this disclosure provides the application of approximate amplitude encoding (AAE) technique for encoding radio signal data. Overall, with comprehensive simulations, our results shed new light on the growing field of quantum machine learning by uncovering advantages of applying quantum ML methods in practical applications where adversarial considerations are inevitable.

### Adversarial Attacks for Wireless Communication Systems

This section provides a detailed procedure for performing different adversarial attacks on modulation classification. Such examples comprise a wireless communication system with a transmitter, a receiver and an attacker. The transmitter transmits signals with one specific modulation type. The receiver receives the wireless signal and applies a pre-trained classifier to classify the modulation type that is used at the transmitter. The attacker launches an attack by transmitting a signal to create a low power perturbation and cause misclassification at the receiver.

We denote the modulation classifier at the receiver by f(.;θ) χ→ [symbol] , where θ is the set of model parameters of the classifier, χ∈ [symbol] is the input domain where p is the dimension of the inputs and C is the number of modulation types. For every input x, the classifier assigns a modulation type \hat{l}(x,θ)=arg maxₖfₖ(x,θ) where fₖ(x,θ) is the output of the classifier corresponding to the k th class. If the adversary transmits a perturbation rₓ which causes misclassification at the receiver, we have \hat{l}(x,θ)≠\hat{l}(x+rₓ,θ) and x+rₓ∈χ. Given these definitions, the adversary obtains the adversarial perturbation rₓ for the input x and classifier f by solving the following optimization problem:

$$arg {min}_{{r}_{x}} {‖ {r}_{x} ‖}_{2} s . t . \hat{l} ( x , θ ) \neq \hat{l} ( x + {r}_{x} , θ ) \qquad ( 5 )$$

In practice solving (5) is difficult. Hence, different methods have been proposed to approximate the adversarial perturbation such as fast gradient methods (FGM). There are also two variants of FGM: targeted FGM and non-targeted FGM as described in
Sadeghi, M. and Larsson, E. G. (2018). Adversarial attacks on deep-learning based radio signal classification. IEEE Wireless Communications Letters, 8:213-216,
   which is included herein in full by reference. In a targeted FGM attack, the adversary tries to generate a perturbation that causes the classifier at the receiver to have a specific misclassification, e.g., classifying QPSK modulation as 8PSK modulation. In a non-targeted FGM attack, the adversary generates for a perturbation that causes any misclassification independent of target label. This disclosure focuses on non-targeted adversarial attack algorithms.

In addition to the targeted and non-targeted categories, adversarial attack can also be categorized along other dimensions, such as white-box and black-box attacks. The attack category is determined based on the amount of knowledge that the adversary has about the model. In white-box attack, the adversary is considered to have the full knowledge of the classifier, while in black-box attack, the adversary has no or limited knowledge of the classifier.

This disclosure provides an application of QVCs on radio signal classification and a study of its robustness to various adversarial attacks. For the white-box adversarial attacks, the adversary is assumed to know the model architecture and input data of the classifier at the receiver.

### White-Box Attack

### Fast Gradient Sign Method

As mentioned above, FGM can be used for solving eq (5). Let J(θ, x, y) be the cost function used to train the modulation classifier f(.;θ), where y is the label vector. In one example, the disclosed methods use a fast gradient sign method(FGSM) which utilizes L_{∞} bounded constraint and the sign function to get the gradient direction. It then takes a small step in the gradient direction that will maximize the loss until suitable perturbation is reached:

$$η = ϵsign ( {∇}_{x} J ( θ , x , y ) ) \qquad ( 6 )$$

### Projected Gradient Descent

FGSM is a one-step scheme to generate powerful adversarial attack. There is an improvement of multi-step variant to FGSM, which is referred to as projected gradient descent (PGD). PGD first uniforms the random perturbation as the initialization, and then generates the perturbation by running several iteration of FGSM. Formally, the iterative process is presented as follow:

$${x}^{t + 1} = {\prod }_{x , ϵ} \{ {x}^{t} + αsign {∇}_{x} J ( θ , x , y ) \} , {x}^{0} = x \qquad ( 3 )$$

where Π denotes the projection operator, which clips the adversarial examples around the predefined perturbation range. α represents the gradient step size.

### Universal Adversarial Perturbations

FGSM attack and PGD attack have some limitations. First of all, the adversary needs to know the full input data. Secondly, each input data x is perturbed by its corresponding noise rₓ. In other words, the adversary knows the input of the classifier, which is impractical. These limitations can be addressed by introducing an input-agnostic algorithm. Specifically, instead of generating perturbations rₓ corresponding to each input x, a universal adversarial perturbation r is generated to fool the classifier with high probability. We refer to the algorithm as Universal Adversarial Perturbations (UAP).

The UAP algorithm utilizes principal component analysis (PCA) to craft the perturbations. Assume the adversary collects an arbitrary subset of inputs {x₁, . . . , x_{N}} and the corresponding perturbation directions {nₓ_{₁} . . . , nₓ_{_{N}}} is known, where nₓ_{ᵢ}=∇ₓ_{ᵢ}L(θ,xᵢ,y^{true})/∥∇ₓ_{ᵢ}L(θ,xᵢ,y^{true})∥₂ [. We stack nₓ_{₁} to nₓ_{_{N}} into a matrix, then perform PCA to find the first principal component of the matrix with the largest eigenvalue. The direction of the first principal component will account for the most variability in {nₓ_{₁}, . . . , nₓ_{_{N}}} which is proposed to be used as the direction of the UAP. FIG. 25 shows a pseudo-code for the PCA-based UAP algorithm.

### Black-Box Attack

In black-box attack scenario, we relax the information about the classifier at the receiver. That is, we assume no information about the internal structures of the classifiers and the learning algorithms. In order to achieve this assumption, we utilize the transferability property of adversarial examples. This property states that, with high probability, adversarial example crafted to fool one specific learning model can fool another model even if their architecture differ greatly or they are trained on different sets of training data.

The transferability of adversarial examples is now used in a different setting for black-box attack. That is, to craft adversarial examples for classical CNN model, we first use the quantum classifier QVC as a substitute model, derive adversarial examples from it the same way as in white-box attack, and then apply them on the CNN model to investigate whether they transfer to the classical classifier. Similarly, to craft perturbations for quantum classifier, we use the CNN model as a substitute model and derive adversarial examples from it the same way as in white-box attack and then apply them on the QVC and QVC with Approximate Amplitude Encoding for investigation.

### Datasets and Methods

We compare the performance and robustness of QVC and CNN under the three types of attacks introduced above under both white-box and black-box scenario. For the classical CNN model, we provide details of the model architecture and hyper-parameters used in this work below. For the quantum classifier QVC, we provide details of the model below. Both models are trained using the same GNU radio ML dataset RML2016.10a and our synthetic Fourier series waveform dataset.

### GNU Radio ML Dataset

The GNU radio ML dataset is available at https://www.deepsig.ai/dataset. It is a synthetic dataset, generated with GNU Radio, consisting of 10 modulations. GNU radio ML dataset is a variable-SNR dataset with moderate LO drift, light fading, and numerous different labelled SNR increments for use in measuring performance across different signal and noise power scenarios. The dataset contains 200,θ00 signal samples where each sample belongs to a specific modulation class at a specific signal-to-noise ratio (SNR). The dataset is balanced. There are 10 modulation classes and each contains the same number of signal samples for 20 different SNR levels from −20 dB to 18 dB with an interval step of 2 dB. Each sample holds a 128 in-phase and 128 quadrature components as a 2×128 matrix. In order to reduce the computation burden of training large quantum classifiers, we randomly sample equal number of signal data from Rwo (8PSK vs GFSK) and three (8PSK vs GFSK vs CPFSK) modulation classes at the SNR=16 dB to perform analysis on binary and 3-class (multi-class) classification respectively. Specifically, we sample 5000 data points per class for training and 500 per class for testing. Visualization of signal data for each modulation class can be found in FIG. 4 in Appendix. We refer to this dataset as RML dataset in the paper.

### Synthetic Fourier Series Dataset

Fourier series can describe a periodic signal in terms of cosine and sine waves. In other words, it allows to model any arbitrary periodic signal with a combination of sines and cosines. The motivation for creating this synthetic dataset is to verify the robustness of quantum classifiers to adversarial attacks on any signals that can be decomposed using Fourier series. Specifically in this paper, we use Fourier series for three different types of periodic signals, square waves, sawtooth waves and triangle waves. For each type, we generate 5000 data points for training and 500 data points for testing. Each data point has added Gaussian noise and has varying frequency. Visualization of signal data for each class is shown below.

### Quantum Classifier

Quantum classifiers can only take quantum states as input. Thus, when classifying classical data using QVC, we first convert classical data into quantum states. There are two common ways of encoding classical data into quantum states: amplitude encoding and phase encoding. In an n-qubit system, applying amplitude encoding can map an input vector x∈ [symbol] directly into the amplitudes of the 2ⁿ dimensional ket vector |φ [symbol] iₙ (p≤2ⁿ). Amplitude encoding takes the advantage of exponentially large Hilbert space of the quantum computer, however, it uses exponentially deep encoding quantum circuits. In contrast, phase encoding is more efficient in terms of circuit depth but it uses p qubits to encode the input vector, which may limit the ability to encode complex datasets.

For the RML dataset, the classical input data is of dimension p=256, in the form of vectors with 256 components. Amplitude encoding is chosen as an example loading method as only 8 qubits are needed to encode all 256 components. We use two methods of amplitude encoding; the first being an exact encoding, where the amplitudes are calculated directly from the classical data and loaded onto the qubits, and the second being an approximate amplitude encoding (AAE) method that uses on a parameterised circuit to approximate the correct amplitudes.

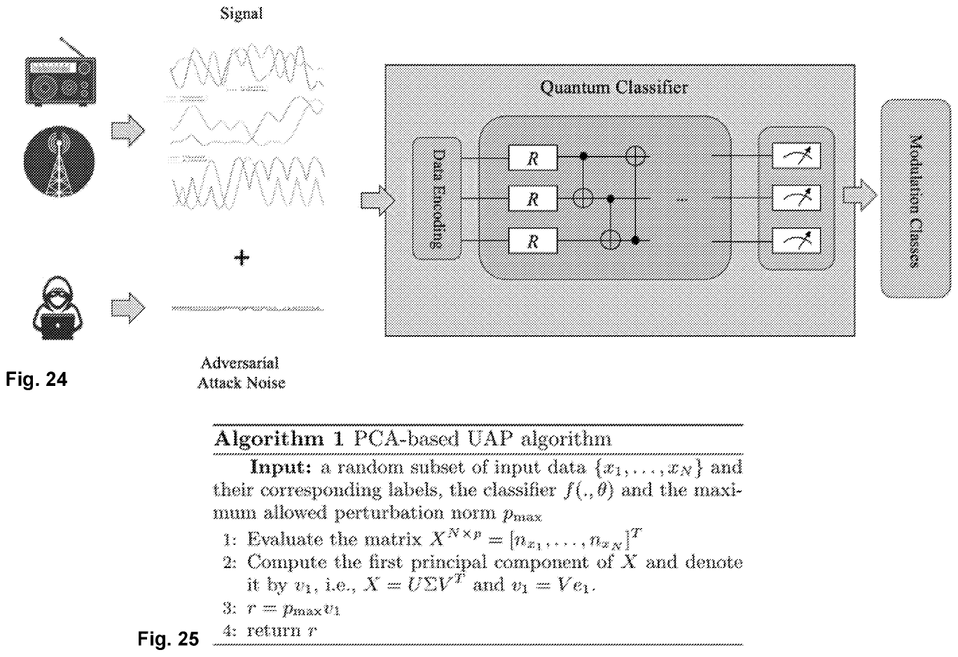

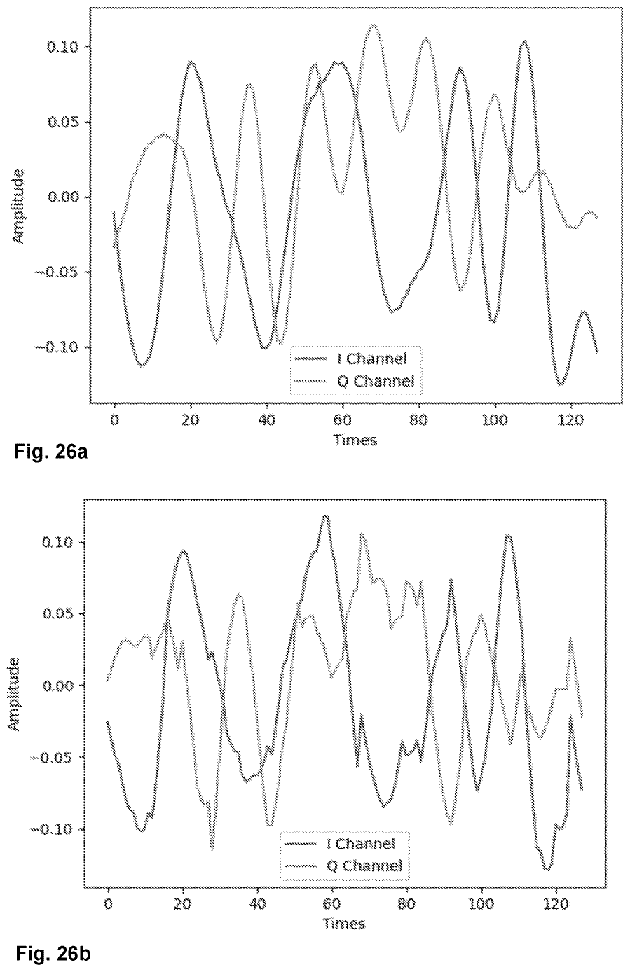

After encoding the classical data, the method uses an optimisable quantum variational circuit (QVC) before measurements to determine the prediction of the classifier. A QVC consists of a repeated layer of a number of parameterized single-qubit gates followed by two-qubit entanglement gates (see FIG. 24). The parameters of the single qubit gates are classically optimized to minimize the differences between predicted class and actual class, similar to classical neural networks. A more detailed discussion on hyperparameters and implementation details of the QVC is given below.

### Approximate Amplitude Encoding

Although amplitude encoding offers a highly efficient way of encoding data for QML, such encoding schemes may use large circuit depths to implement. The number of gates used to load data into a quantum circuit scales as 2ⁿ where n is the number of qubits data is loaded onto, meaning that unless we are working with very few qubits, the amplitude encoding process is likely to dominate runtimes in QML implementations. The average number of gates for encoding our input data is almost 1000, while roughly 2500 CNOT gates may be used to encode image data onto 9 qubits. Furthermore, unless we are working with very few qubits, the generic amplitude encoding process is prone to accumulating errors during physical implementation as a result of the high gate count, even before any computation is performed on the encoded data.

One solution to this problem is to use an approximation of the true amplitude encoding process to encode data. Instead of using exact amplitudes obtained with the usual amplitude encoding process to encode data, we use approximations of these exact amplitudes instead. The number of gates required to produce the approximate amplitudes is far smaller than the number required to produce the exact amplitudes. Although there is an inherent loss of data in this encoding approach, it offers a major advantage by dramatically reducing the circuit depth needed for encoding, thereby making it suitable for implementation and application in the NISQ era where some degree of error or noise in the data is tolerable.

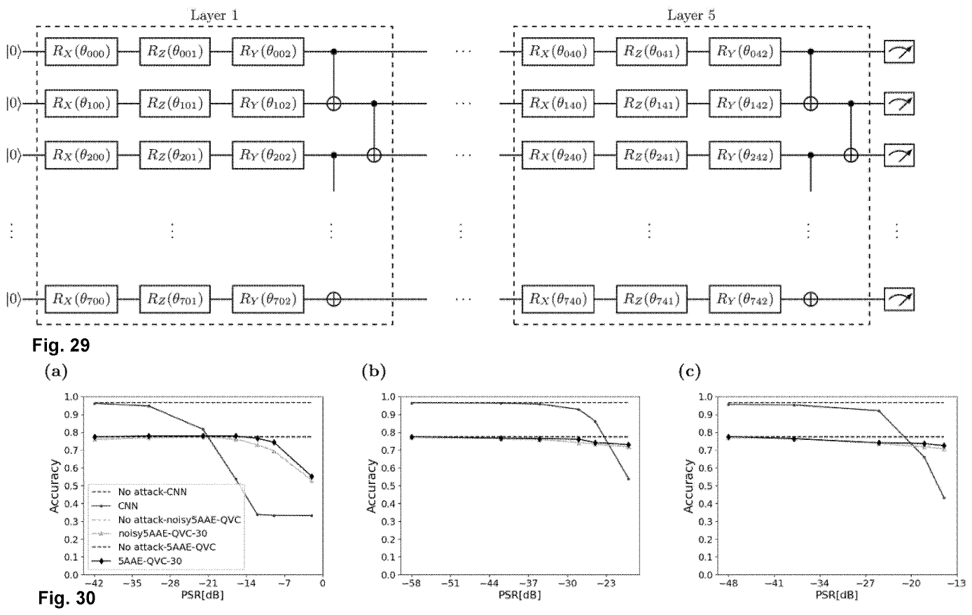

The method of approximate amplitude encoding employed in this disclosure may involve the training of a shallow QVC to produce approximations of the amplitudes that would be obtained through the generic method of amplitude encoding (hereafter referred to as exact amplitude encoding). We use 8 qubits to encode the 256 components to the input signal data, where each qubit is initialised to the zero state. The variational component of the circuit is made up of 1 layers where each layer consists of a sequence of 3 rotation gates per wire: a rotation about the X-axis (R_{X}), rotation about the Z-axis (R_{Z}) and a rotation about the Y-axis (R_{Y}), followed by a Controlled-NOT gate connecting two adjacent wires. The rotation angles of the R_{X}, R_{Z} and R_{Y} gates constitute the trainable parameters of the QVC (24 parameters per layer). For most of this study, we choose l=5 layers (equivalent to 360 trainable parameters), as this is sufficient to approximate the original amplitudes to a fidelity of approximately 0.89-0.90. The structure of the circuit is depicted in FIG. 29.

The goal when training the encoding QVC was to train the parameters so that the output (“predictions”) from the QVC matches as well as possible the exact amplitudes obtained from amplitude encoding (“labels”). Mathematically, we are producing approximate amplitudes through the application of the QVC to an initial zero state:

$$U ( θ ) {0}^{⊗ n} = {\sum }_{j = 0}^{N - 1} {a}_{j} j , \qquad ( 8 )$$

where U(θ) represents the QVC to be trained, with trainable parameters given by the vector θ, N is the number of available quantum states and is equal to 2ⁿ where n is the number of qubits that will encode the data, and {aⱼ} are the amplitudes, obtained from the approximate encoding, and associated with the quantum states given by j=j₀j₁ . . . j_{N-1} where jₖ represents the state of the k-th qubit in the computational basis. Thus, the right-hand side of the equation above is the quantum state obtained after the approximate amplitude encoding process.

We trained the parameters of U(θ) to best match the following criterion:

$${\vert {a}_{j} \vert}^{2} = {\vert {A}_{j} \vert}^{2} , ∀ j ∈ [ 0 , 1 , … , N - 1 ] , \qquad ( 9 )$$

where {Aⱼ} are the amplitudes obtained from exact amplitude encoding, and which the amplitudes {aⱼ} are approximating. However, we utilised an indirect method to optimise the above equation, involving training the inverse of the desired QVC, namely U⁻¹(θ̅), to produce the initial input state, 0^{237 n}, and using the desired output amplitudes as input to the inverse QVC. As such, the parameters θ̅ of U⁻¹(θ̅) were trained to satisfy the condition:

$${\vert {\overline{a}}_{0} \vert}^{2} = {\vert {\overline{A}}_{0} \vert}^{2} = 1 , \qquad ( 10 )$$

where ā₀ and Ā₀ are the approximated and exact amplitude of the state 0^{237 n}, which is equal to 1 since the input state to U(θ) consists entirely of this zero state. Training U⁻¹(θ̅) to satisfy Equation 10 is equivalent to training U(θ) to satisfy Equation 9. The desired parameters θ are obtained from the trained parameters θ̅ by reversing the order of the components of the vector and flipping their signs.

We used Pennylane's implementation of the Adam optimisation algorithm, with a step size of 0.1 over 300 iterations. We also used values β₁=0.9 and β₂=0.99 for the hyper-parameters governing the updates of the first and second moments, and ∈=10⁻⁸ for the numerical stability offset. As mentioned above, we optimised based on the probabilities of measuring specific quantum states, with the view of implementing on quantum computers where state probabilities, not amplitudes, are observable and measurable. However, the use of probabilities does not allow global phases to be measured or approximated, meaning that the approximate amplitudes produced through this method include some unpredictable global phase given by e^{iφ}. Thus, the approximate amplitudes may have both a real and imaginary component, and may be flipped in sign relative to the original amplitude. For this study, we keep the global phase in the approximated amplitudes, as we find that removing the phase does not significantly impact the classification accuracies achieved by the signal-classifying QVC.

We use encoding fidelity as a measure of similarity between the approximate amplitudes and the exact amplitudes, defined as follows:

$$F = {\vert {ψ}_{ρ} \vert {ψ}_{σ} \vert}^{2} , \qquad ( 11 )$$

where F is the encoding fidelity, and ψ_{ρ} and ψ_{σ} represent the pure quantum states defined by the approximate amplitudes and the exact amplitudes, respectively.

Although individual encodings for specific signals will vary with each run, we find that on average, the fidelities achieved with the approximate amplitudes vary only slightly per experiment. Using 5 encoding layers, we achieve a mean fidelity and standard deviation of 0.8957±0.0003 from calculating approximate amplitudes for the multi-class RML dataset 10 times. As the variation is very small, we report the fidelities in our results section to 3 significant figures and do not report uncertainties in their value.

### Robustness Against Adversarial Attacks

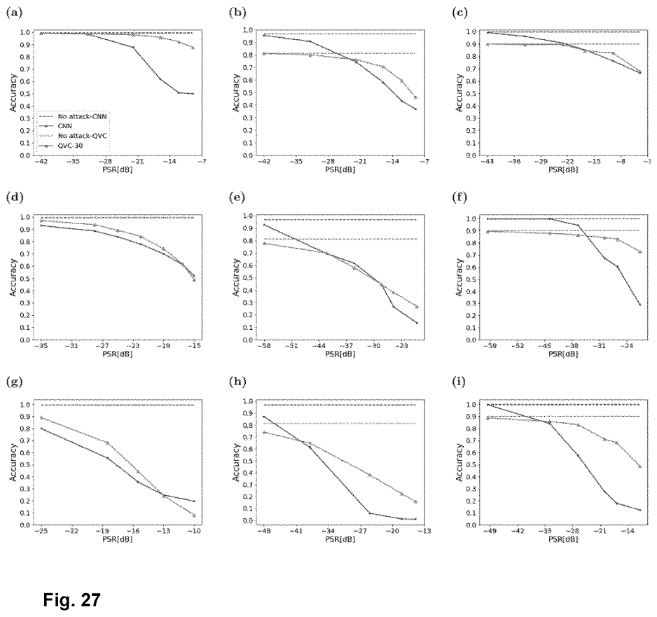

In FIG. 27, we plot the performance achieved by the QVC and CNN models in the case of white-box UAP, FGSM and PGD attacks on the RML dataset (first two columns) and our synthetic dataset (last column) as a function of PSR. We label the QVC models with the number of layers in the architecture, e.g., QVC30 consists of 30 layers. The performance of each model without adversarial attacks is presented in the figure as straight dashed lines. While QVC exhibits comparable accuracy to CNN in binary classification and slightly lower accuracy in multi-class classification, we find that, when subjected to the same PSR level and tested against three distinct types of adversarial attacks in a white-box scenario, QVC (highlighted in purple) generally demonstrates a slightly higher level of robustness compared to CNN. Nevertheless, as the PSR level increases, the accuracy of QVC still experiences a significant decline, thereby revealing its vulnerability to white-box adversarial attacks.

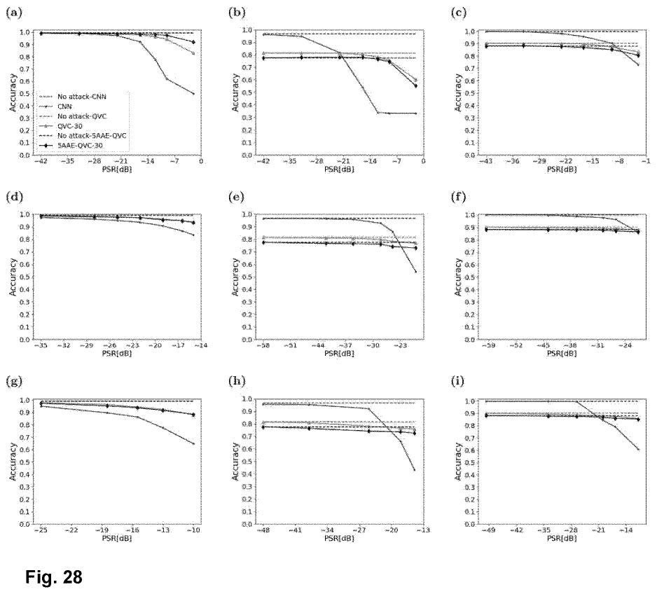

In FIG. 28, we show the accuracy achieved by QVC, AAE-QVC and CNN in the case of black box UAP, FGSM and PGD attacks on the same sets of datasets as a function of PSR. Similarly, the straight dash lines represent the initial accuracy of the algorithms without any attacks. Across different attack types and datasets, we witness that attacks generated on quantum classifiers exhibit strong transferability to classical CNN models, resulting in a significant reduction in CNN accuracy. For instance, when evaluating the robustness against a black-box PGD attack on the multi-class RML dataset, as depicted in FIG. 28, the CNN's accuracy plummets from 96.7% to 43.4%. These adversarial examples effectively deceive the neural networks which they are not explicitly designed to attack. However, the converse scenario is not true. Quantum classifiers, namely QVC and AAE-QVC, show substantial resilience against attacks generated on convolutional neural network. Their accuracy remains relatively stable even as the PSR level increases. Classification accuracy

TABLE 1
Classification accuracy of CNN, QVC-30 and 5AAE-QVC-30 for Binary
RML, Multi-class RML and synthetic Fourier series datasets.

| Dataset | CNN | QVC-30 | 5AAE-QVC-30 |
|---|---|---|---|
| Binary RML | 0.995 | 0.993 | 0.992 |
| Multi-class RML | 0.967 | 0.812 | 0.775 |
| Synthetic | 0.998 | 0.902 | 0.881 |

Table 1 displays the classification accuracy attained by each of the CNN, QVC-30 and 5AAE-QVC-30 models. Across different datasets, CNN achieves the highest classification accuracy, followed by QVC-30 and 5AAE-QVC-30. While the classification accuracy of QVC-30 matches the accuracy achieved by the CNN in the binary classification problem, we find that it has a significantly lower accuracy than CNN for the multi-class problem. This may be the result of insufficient complexity in the QVC model compared to the CNN model, which a multi-class problem would require. Increasing the number of layers or qubits in the QVC could improve the accuracy, though such changes will increase the computational burden. In all datasets, the 5AAE-QVC-30 model accuracies are slightly lower than the QVC-30 accuracies, due to the unavoidable loss of data inherent in the amplitude approximation process.

In Table 2, we report the encoding fidelities and classification accuracies for approximate encoding circuits with varying circuit depth. The dataset used for these results is the multi-class RML dataset, consisting of 16,500 samples of data. The number of gates per encoding layer is 31, so the total gate number for each experiment is the number of encoding layers multiplied by 31. We report baseline results for the exact encoding case for comparison, where the classification accuracy is 0.812 when we use exact amplitudes as input to the QVC, and where an average of 973 gates (or roughly 121 gates per qubit) is required to perform exact amplitude encoding across the dataset.

We find that the encoding fidelity increases with number of layers used in the approximate encoding circuit, which is unsurprising as having more trainable parameters tends to produce better approximations. Our results show that very high accuracies can be achieved despite significant reduction in the number of gates used to encode the data. The success of the approximate encoding method is most apparent in the results obtained with 15 and 20 encoding layers. With only 465 gates, less than half the number of gates necessary for exact encoding, we are able to achieve an accuracy of only 2.7% below the peak classification accuracy obtained with exactly encoded amplitudes. This difference shrinks to below one percent when encoding with 20 layers, which is less than two thirds the number of gates required for exact encoding. The decision to use approximate encoding, and the choice of layer depth, depends on the accuracy one is willing to accept for the problem at hand. For example, if a loss of accuracy of 3% is acceptable, then we can use the much shallower encoding circuit to calculate the amplitudes.

TABLE 2
Classification accuracy of Multi-class RML dataset with QVC-30
using different approximate amplitude encoding (AAE) layers.

| Number of Approx. | Encoding | Classification | Total Number |
|---|---|---|---|
| Encoding Layers | Fidelity | Accuracy | of Gates |
| 3 | 0.731 | 0.746 | 93 |
| 5 | 0.895 | 0.775 | 155 |
| 10 | 0.944 | 0.779 | 310 |
| 15 | 0.951 | 0.785 | 465 |
| 20 | 0.988 | 0.803 | 620 |
| Exact Encoding | 1.00 | 0.812 | 973 |

### Data Stealthiness

Attack stealthiness is an important characteristic of adversarial attack. A successful stealthy attack is considered as not perceptible and hard to detect. In this section, we propose a statistical analysis to compare the stealthiness of adversarial attacks generated by QVCs and classical CNNs. An attack is imperceptible if we detect at least one modulation class which has a similar data distribution of radio signal data as that of the adversarially crafted radio signal data. For this purpose, we apply the Two-sample Kolmogorov-Smimov goodness of fit test (KS-test). Basically, for an adversarial example \tilde{x}, we apply the KS-test on every pair of (\tilde{x},xᵢ) where xᵢ is from the original dataset. KS-test will return the p_value which is compared with a significant level of a. If p_value >α, we claim that the adversarial example is similar to the original data of at least one class. In practice, we set the significant level α to 0.05 and recommended as a standard level. A pseudo-code of the algorithm is presented below. In table 3, we present the percentage of perceptible adversarial examples generated by QVCs and CNNs for multi-class RML dataset using FGSM and PGD attacks under the white-box scenario. Under different PSR values for the FGSM and PGD attacks, adversarial examples generated by QVC-30 are considered more imperceptible than adversarial examples generated by CNN. Additional perceptible perturbation analysis for the remain scenarios are shown further below.

TABLE 3
The percentage of out-of-distribution (detectable) adversarial
examples generated by QVCs and CNNs for multi-class RML dataset
under FGSM and PGD attack. Under different PSR values for the
FGSM and PGD attacks, adversarial examples generated by QVC-30
are considered generally more imperceptible (harder to detect)
than adversarial examples generated by CNN.

| PSR (FGSM attack) | −58 dB | −42 dB | −35 dB | −28 dB | −25 dB |
|---|---|---|---|---|---|
| QVC30 | 0.3% | 0.3% | 0.5% | 0.7% | 2.4% |
| CNN | 1.1% | 2.1% | 4.5% | 6.7% | 14.9% |
| PSR (PGD attack) | −48 dB | −38 dB | −25 dB | −18 dB | −15 dB |
| QVC30 | 0.3% | 0.3% | 0.6% | 1.7% | 2.4% |
| CNN | 0.3% | 2.1% | 6.1% | 18.5% | 28.1% |

### Effects of Quantum Noise

The above experimental results of quantum classifiers presented so far are from noise-free quantum simulations. However, to run QML algorithms on a quantum machine, quantum noise may be present. To take into consideration of any effects of quantum noise on the robustness of QVCs and approximate amplitude encoding, we assess quantum noise channels on our AAE-QVC model and its robustness to adversarial attacks through noise simulations. The quantum noise channel we experiment with is depolarizing error. Depolarizing error is modelled by the following Kraus matrices:

$${K}_{0} = \sqrt{1 - p} [ \begin{matrix}1 & 0 \\ 0 & 1\end{matrix} ]$$

$${K}_{1} = \sqrt{p / 3} [ \begin{matrix}0 & 1 \\ 1 & 0\end{matrix} ]$$

$${K}_{2} = \sqrt{p / 3} [ \begin{matrix}0 & - i \\ i & 0\end{matrix} ]$$

$${K}_{3} = \sqrt{p / 3} [ \begin{matrix}1 & 0 \\ 0 & - 1\end{matrix} ]$$

where p∈[0,1] is the depolarization probability and is equally divided in the application of all Pauli operations. To simulate this noise channel, we use a depolarization probability of 0.02 on every qubit and every AAE and QVC layer. We train the QVC with approximate amplitude encoding and with this noise channel on the same multi-class RML radio dataset. The performance is presented in FIG. 30. Based on the results, it is evident that introducing depolarization noise with a probability of 0.02 leads to a significant drop in classification accuracy from 77.5% to 62.8%, however, it does not affect QVC model's robustness towards black-box adversarial attacks generated from classical CNN model.

### CONCLUSIONS

This disclosure provides a systematic and extensive assessment of the robustness of QVCs in the presence of various adversarial attacks and in comparison of classical CNN model on the RML dataset and synthetic Fourier series waveform dataset. In addition, this disclosure proposes the application of approximate amplitude encoding technique on radio signal data. This disclosure answers key questions such as how well will QML algorithms fare against strong classical adversarial attacks for radio signal datasets, are the robustness and attack transferability of QAML in signal data classification behave similarly as in image classification, and whether the perturbed radio signal data generated by attacking quantum models are more imperceptible than data generated by attacking classical classifiers.

In summary, vulnerability to intentionally-crafted adversarial attacks has recently raised major security concerns of classical and quantum ML algorithms. This disclosure addresses an important gap in the QAML literature by thoroughly studying the robustness and attack transferability of adversarial examples between classical and quantum neural networks in the context of radio frequency datasets. By discovering the failure of the classical adversarial examples to transfer to the QVCs in signal classification, we witness that the quantum ML models are generally impervious to the adversarial attacks which targeted the precise features learnt by the classical networks. Such a scenario will offer a new form of advantage in QML. Moreover, by studying the data stealthiness of the adversarial examples, we discovered that, for attackers, adversarial attacks generated on quantum models are generally more imperceptible. Quantum ML classifiers which may not be necessarily more accurate than their classical counterparts, but provided superior robustness to adversarial attacks and can generate more imperceptible attacks.

### Hyperparameters and Implementation Details

Table 8 and table 9 give a list of hyperparameters used in the experiments. Hyperparameters are made the same across different attack scenarios to ensure fairness and consistency in comparisons. Our convolutional neural network begins with one layer of 1×3 filter with 32 feature maps, and ReLU activation function. The convolutional layer is followed by two fully connected layers, which also utilize ReLU activation function. The dropout rate is set to 0.2. Table 10 lists the number of parameters required for the different models considered. Quantum variational circuits require drastically fewer trainable parameters than the classical counterpart.

TABLE 8
Hyperparameter values for QVC

| Hyperparameters | QVC |
|---|---|
| optimizer | RMSprop |
| learning rate | 5 · 10 − 3 |
| number of QVC layers | 30 |
| batch size | 256 |

TABLE 9
Hyperparameter values for CNN

| Hyperparameters | CNN |
|---|---|
| optimizer | Adam |
| learning rate | 1 · 10 − 3 |
| batch size | 256 |
| Nonlinearity | ReLU |
| Padding layer | (0, 2) |
| Conv layer | (32, 1, 3) |
| Dropout | 0.2 |
| Flatten | — |
| FC | (16) |
| FC | (2) or (3) |

TABLE 10
The number of parameters required for QVCs and CNNs.

| | | 3-class | | | | |
|---|---|---|---|---|---|---|
| | Binary | Param- | | | Param- | |
| Network | Qubits | eters | Layers | Qubits | eters | Layers |
| CNN | — | 133,298 | 3 | — | 133,315 | 3 |
| QVC-30 | 8 | 720 | 30 | 8 | 720 | 30 |

### Two-Sample Kolmogorov-Smirnov Goodness of Fit Test

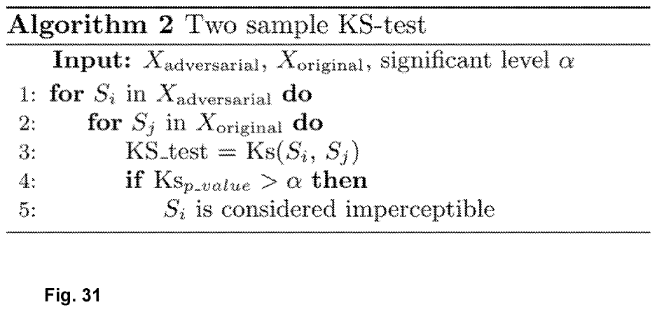

In FIG. 31 we provide the pseudo-code for the Two-sample Kolmogorov-Smirnov goodness of fit test (KS-test) applied above. We set the significant level α to 0.05.

### Visualization of Datasets

FIG. 32 provides a visualization of GNU Radio ML dataset for three different modulation classes at the SNR=16 dB.

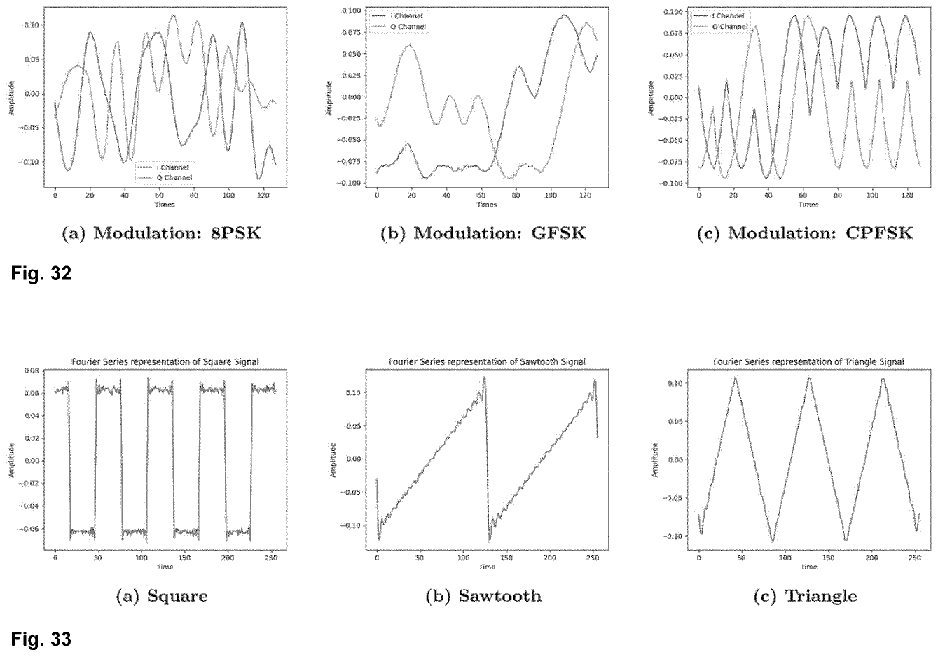

FIG. 33 provides a visualization of the Synthetic Fourier Series dataset. Three different types of periodic signals, square waves, sawtooth waves and triangle waves are generated in the dataset. Each data point has added Gaussian noise and has varying frequency. Figure (a) to (c) show the visualization of the three different periodic signals respectively.

### Visualization of Adversarial Examples

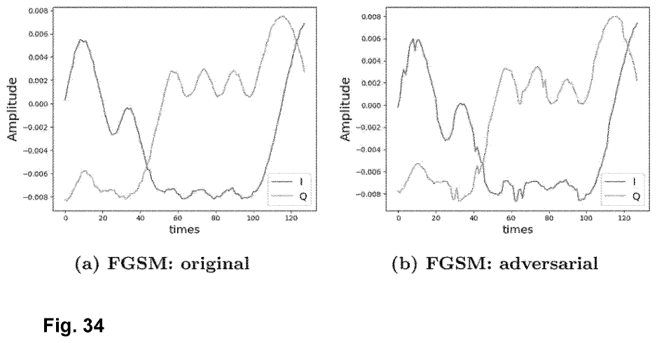

FIG. 34 shows a visualization of an FGSM attack with PSR=−42 [dB] on signal data with modulation class equals GFSK. The original signal data is shown on the left. The perturbated signal data is shown on the right.

### Data Stealthiness

TABLE 11
The percentage of out-of-distribution (detectable) adversarial
examples generated by QVCs and CNNs for binary RML dataset
under FGSM and PGD attack. Under different PSR values for
the FGSM and PGD attacks, adversarial examples generated
by QVC-30 are considered generally more imperceptible (harder
to detect) than adversarial examples generated by CNN.

| PSR (FGSM attack) | −58 dB | −42 dB | −35 dB | −28 dB | −25 dB |
|---|---|---|---|---|---|
| QVC30 | 0.1% | 0.6% | 1.1% | 1.8% | 2.8% |
| CNN | 2.3% | 4.7% | 6.8% | 7.2% | 9.3% |

| PSR (PGD attack) | −48 dB | −38 dB | −25 dB | −18 dB | −15 dB |
|---|---|---|---|---|---|
| QVC30 | 0.6% | 2.9% | 5.8% | 8.1% | 13.8% |
| CNN | 4.4% | 6.3% | 7.7% | 10.4% | 16.6% |
| PSR (UAP attack) | −42 dB | −32 dB | −22 dB | −16 dB | −12 dB |
| QVC30 | | | | | |
| CNN | 0.1% | 0.2% | 1.9% | 6.2% | 8.6% |

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A method for detecting an attack on a machine learning system, the method comprising:
evaluating a classical neural network on input data, the classical neural network comprising a first output indicative of a first classification by the classical neural network;
evaluating a quantum neural network on the input data, the quantum neural network comprising a second output indicative of a second classification of the input data by the quantum neural network;
comparing the first output to the second output; and
responsive to the first output being different to the second output, generating an indication that an attack is detected.

2. The method of claim 1, wherein the indication comprises an indication that a classical attack is detected.

3. The method of claim 1, wherein the quantum neural network is a quantum variational classifier.

4. The method of claim 1, wherein the classical neural network is configured for image or signals data processing.

5. The method of claim 1, wherein the classical neural network comprises a convolutional neural network and/or a deep neural network.

6. The method of claim 1, wherein the classical neural network comprises a ResNet architecture.

7. The method of claim 1, further comprising:
evaluating an adversarially trained classical neural network on the input data, the adversarially trained classical neural network comprising a third output indicative of a third classification by the adversarially trained classical neural network;
comparing the second output to the third output; and
responsive to the second output being different to the third output, generating the indication that an attack is detected.

8. The method of claim 7, wherein the indication comprises an indication that a quantum attack is detected.

9. The method of claim 7, further comprising adversarially training the classical neural network by iteratively modifying input data to alter the third output and modifying parameters of the adversarially trained classical neural network to maintain the third output.

10. A quantum neural network comprising:
an encoder configured to encode input data into multiple qubit states;
multiple layers of quantum gates, each layer comprising for each of the multiple qubit states that encode the input data, multiple rotation gates and a controlled z-gate configured to act between two of the multiple qubit states, wherein the multiple rotation gates are tuneable to train the quantum neural network; and
a measurement module to measure the multiple qubit states at an output of the last layer of the multiple layers configured to output a classification of the input data.

11. The quantum neural network of claim 10, wherein each layer comprises exactly three rotation gates.

12. The quantum neural network of claim 10, wherein the controlled z-gate is applied after the multiple rotation gates in each of the multiple layers.

13. The quantum neural network of claim 10, wherein the controlled z-gate is applied between neighbouring qubits of the multiple qubits.

14. The quantum neural network of claim 10, wherein the encoder is configured to perform amplitude encoding.

15. A quantum neural network comprising:
multiple tuneable quantum gates applied to input data of the quantum neural network, and being tuneable to train the quantum neural network to generate a classification of the input data,
wherein the multiple tuneable quantum gates are tuned to provide robustness of the quantum neural network against attacks that modify the input data to alter the classification of the input data.
